(19) United States
(12) Patent Application Publication
(10) Pub. No.: US 2006/0130754 A1
(43) Pub. Date: Jun. 22, 2006

(54) Bowling lane conditioning machine

(75) Inventors: William C. Sias, Muskegon, MI (US); Matthew E. Mead, Whitehall, MI (US); Robert J. Prinz, Muskegon, MI (US); Damir Ibrahimovic, Grandville, MI (US); Patrick J. Mitchell, Muskegon, MI (US); Troy A. Recknagel, Muskegon, MI (US); Roy A. Burkholder, Whitehall, MI (US)

Correspondence Address: BRINKS HOFER GILSON & LIONE, P.O. BOX 10395, CHICAGO, IL, 60610, US

(73) Assignee: BRUNSWICK BOWLING & BILLIARDS

(21) Appl. No.: 11/015,845

(22) Filed: Dec. 17, 2004

(51) Int. Cl. B05C 1/00; B05C 11/00

(52) U.S. Cl. 118/695; 118/207; 118/712

(57) ABSTRACT

A bowling lane conditioning machine is disclosed with circuitry that is operative to perform one or more of the following: dynamically updating a graphical representation of a lane dressing fluid pattern and/or zone, displaying confirmation that a selected component completed a desired function, displaying a log of activity, changing a language of text displayed on a display device, and displaying a graphical user interface with different menu options displayed differently. Also disclosed is a bowling lane conditioning machine with a display device located on a housing and an input device located on a handle, and/or with a first input device located on a handle and a second input device located on a housing. Further disclosed is bowling lane conditioning machine with two processors that operate independently from one another: one that controls a lane dressing fluid application system, and the other that provides a graphic user interface.

### BACKGROUND

Lane dressing fluid, which is sometimes referred to as lane dressing, lane conditioning fluid, lane conditioner, or oil, can be applied to a bowling lane not only to protect the bowling lane from the impact and friction of a bowling ball but also to create a lane dressing fluid pattern on the bowling lane to provide a desired ball reaction. Some currently-available bowling lane conditioning machines contain a user interface that allows a user to adjust a lane dressing fluid pattern. For example, the Levab X-Treme by Levab International and the Phoenix-S by Kegel have a built-in LCD text display and keypad, and the Chairman by Century has a built-in text monitor and keypad. Some users may find such systems difficult to use because they require the user to think in “machine language.” For example, to adjust the shape of an oil pattern using the Levab X-Treme, the user enters parameters such as initial thickness, acceleration threshold, and total distance—parameters that may not be intuitive to a user who simply knows that he wants to apply X units of oil at a desired location on a bowling lane. Also, because these currently-available systems only display text, a user may find it difficult to visualize the selected lane dressing fluid pattern. Some currently-available bowling lane conditioning machines can be connected to a personal computer (PC) or notebook computer, which can graphically display a lane dressing fluid pattern. Also, U.S. Pat. No. 5,641,538 describes embodiments in which a lane dressing fluid pattern is graphically displayed.

### SUMMARY

The present invention is defined by the following claims, and nothing in this section should be taken as a limitation on those claims.

By way of introduction, in one preferred embodiment, a bowling lane conditioning machine is disclosed with circuitry that is operative to perform one or more of the following: dynamically updating a graphical representation of a lane dressing fluid pattern and/or zone, displaying confirmation that a selected component completed a desired function, displaying a log of activity, changing a language of text displayed on a display device, and displaying a graphical user interface with different menu options displayed differently. In other preferred embodiments, a bowling lane conditioning machine is disclosed with a display device located on a housing and an input device located on a handle, and/or with a first input device located on a handle and a second input device located on a housing. In yet another preferred embodiment, a bowling lane conditioning machine is provided with two processors that operate independently from one another: one that controls a lane dressing fluid application system, and the other that provides a graphic user interface. Other preferred embodiments are provided, and each of the preferred embodiments described herein can be used alone or in combination with one another.

The preferred embodiments will now be described with reference to the attached drawings.

### BRIEF DESCRIPTION OF THE DRAWINGS

FIG. 1 is a perspective view of a bowling lane conditioning machine of a preferred embodiment.

FIG. 2 is a right-side view of a bowling lane conditioning machine of a preferred embodiment.

FIG. 3 is a left-side view of a bowling lane conditioning machine of a preferred embodiment.

FIG. 4 is a rear view of a bowling lane conditioning machine of a preferred embodiment.

FIG. 5 is a front view of a bowling lane conditioning machine of a preferred embodiment.

FIG. 6 is a perspective view of a bowling lane conditioning machine of a preferred embodiment with its handle in a storage position.

FIG. 7 is a top view of a bowling lane conditioning machine of a preferred embodiment.

FIG. 8 is a block diagram of a control system of a bowling lane conditioning machine of a preferred embodiment.

FIGS. 9-47 are illustrations of displays of a user interface system of a bowling lane conditioning machine of a preferred embodiment.

FIG. 48 is an illustration of a tabular display used to adjust zone lengths in a user interface system of a bowling lane conditioning machine of a preferred embodiment.

FIG. 49 is an illustration of a line graph display of a user interface system of a bowling lane conditioning machine of a preferred embodiment.

FIGS. 50 and 51 are illustrations of three-dimensional displays of a user interface system of a bowling lane conditioning machine of a preferred embodiment.

### DETAILED DESCRIPTION OF THE PRESENTLY PREFERRED EMBODIMENTS

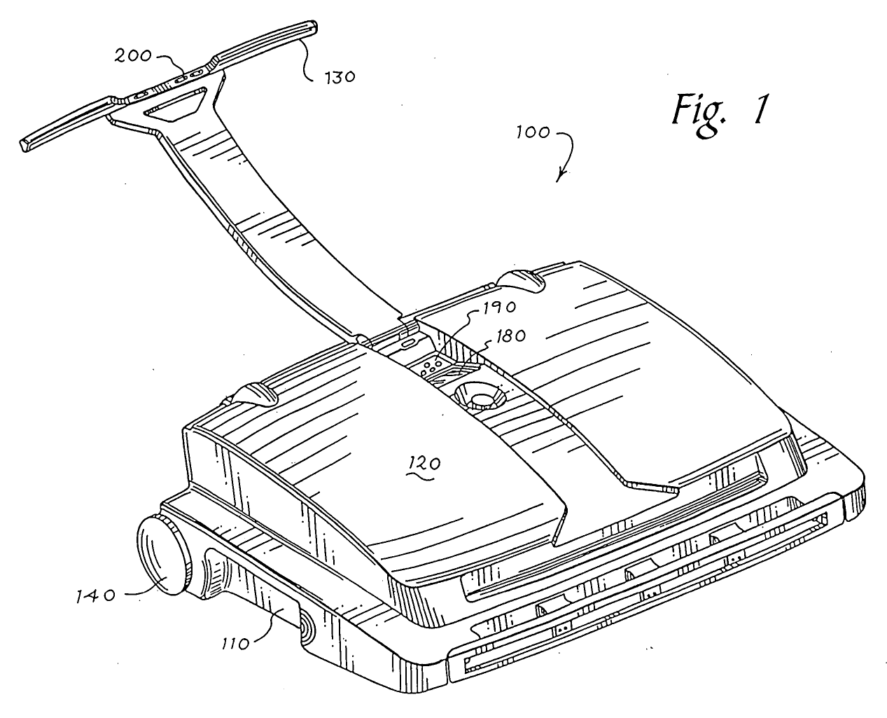

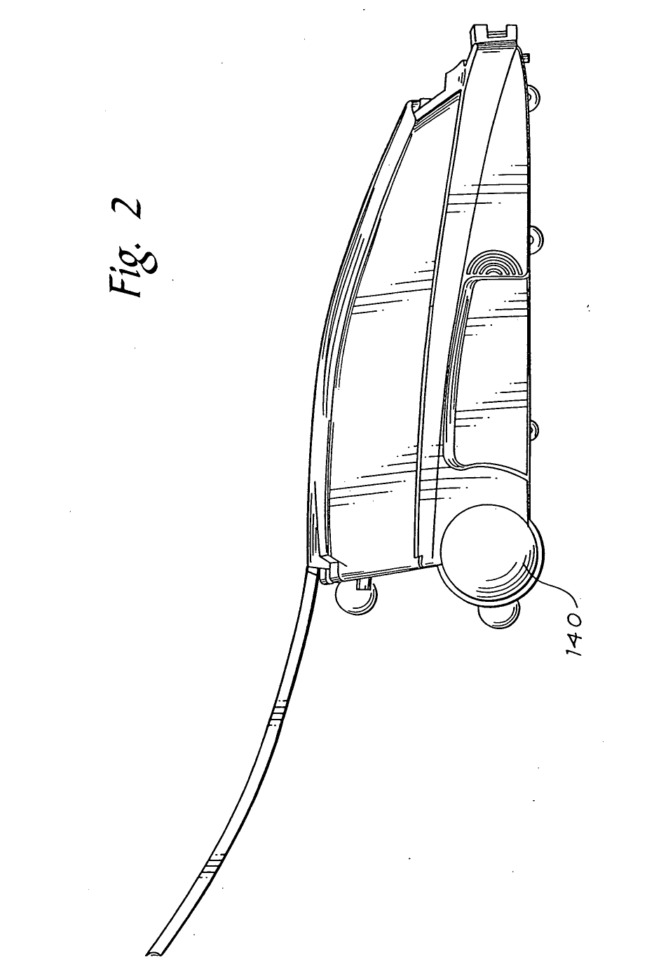

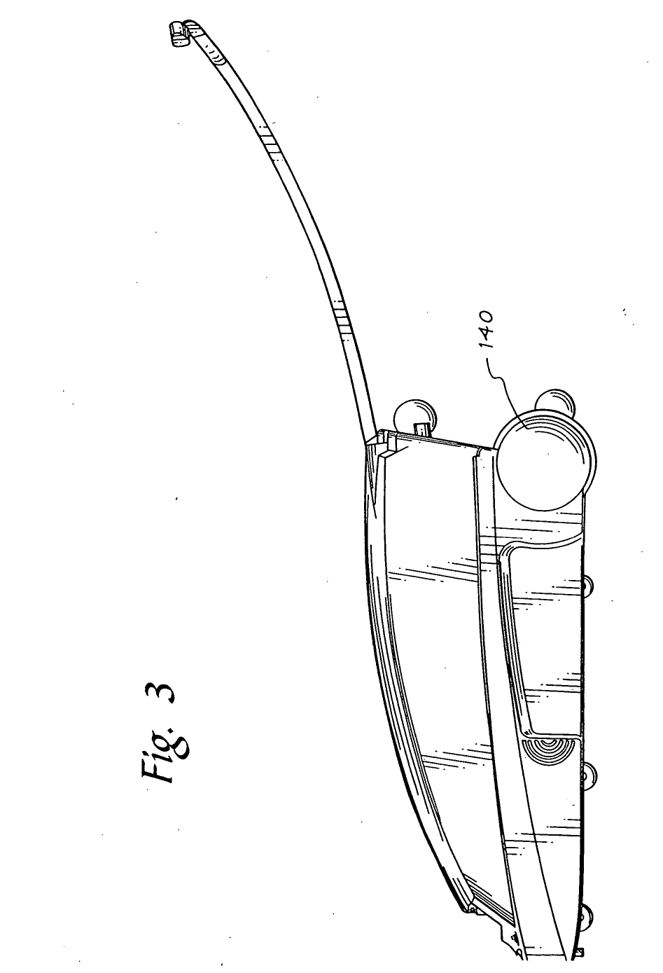

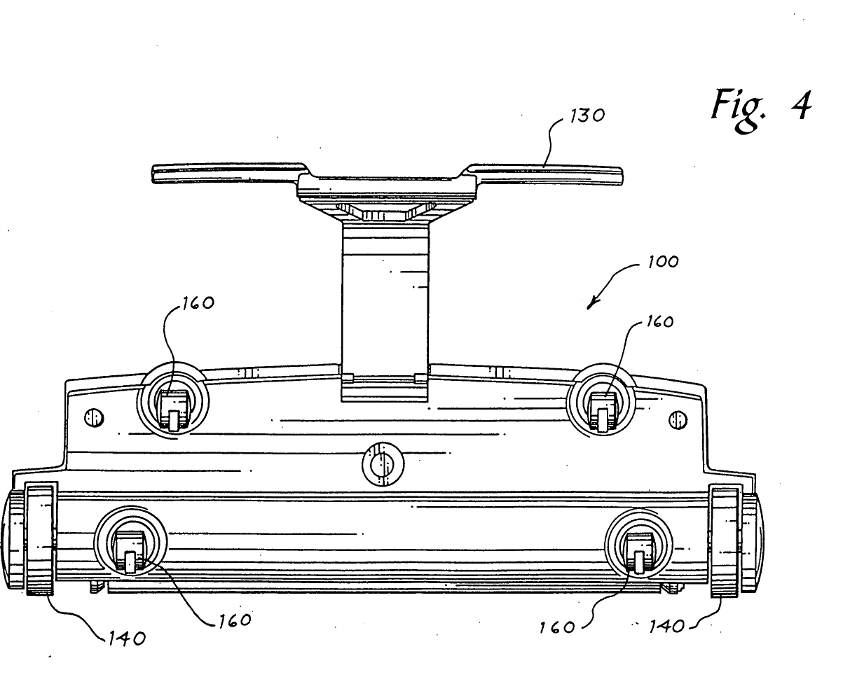

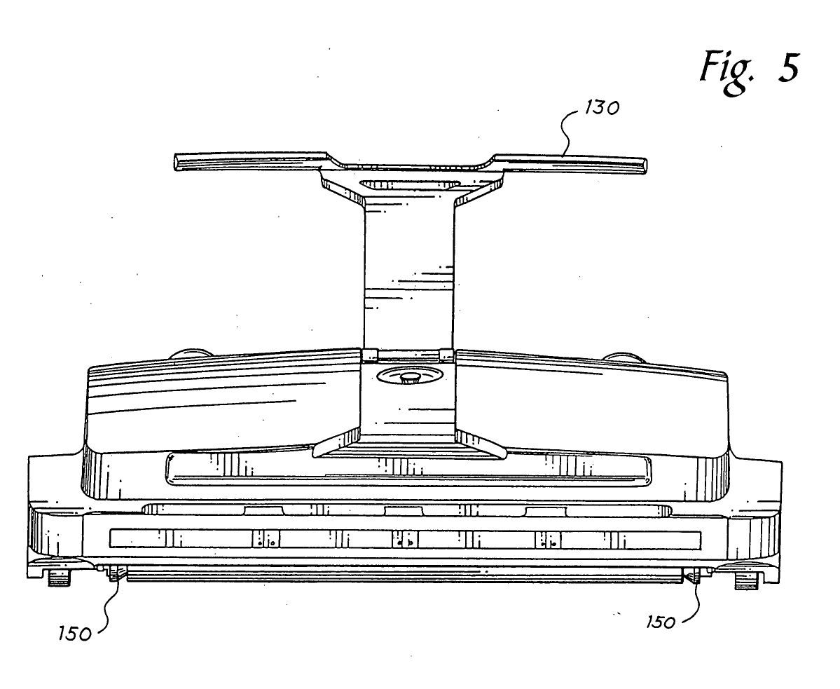

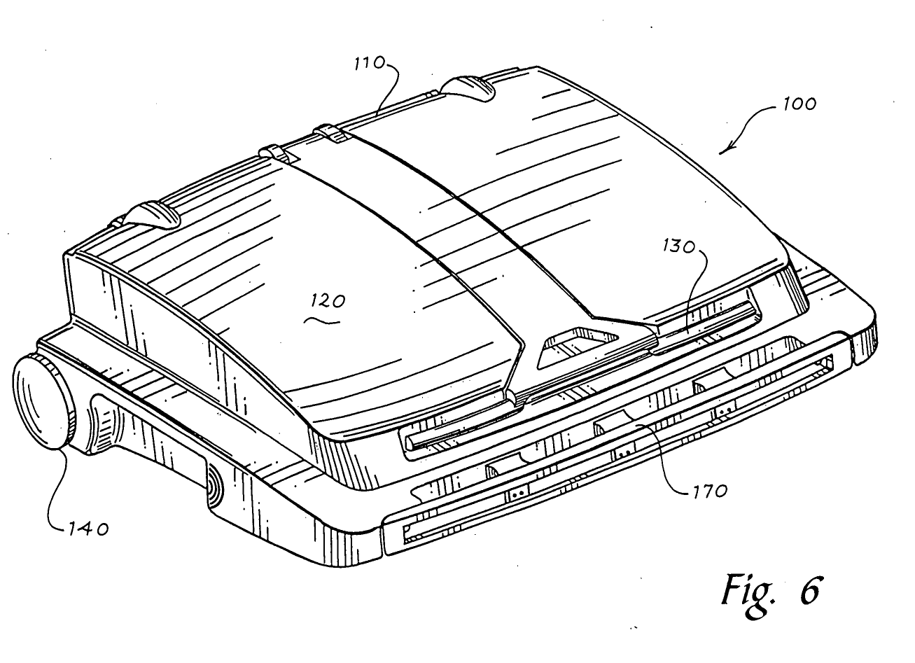

Turning now to the drawings, FIGS. 1-7 show various views of a bowling lane conditioning machine (or “lane machine”) 100 of a preferred embodiment. The lane machine 100 comprises a housing 110 having a top cover 120 and a handle 130. The top cover 120 is hingedly connected to the housing 110 to permit access to the internal components of the lane machine 100. The left and right side walls of the lane machine comprise spaced transition wheels 140 for elevating the lane machine 100 on the approach area and facilitating movement of the lane machine 100 between lanes. When a user pushes the lane machine 100 onto a bowling lane from an approach area using the handle 130, the transition wheels 140 freely hang in the gutters of the bowling lane. As shown in FIG. 5, the lane machine 100 comprises transfer wheels 150 that prevent the front wall from contacting the bowling lane when the lane machine 100 is pulled off the lane and onto the approach area and when the lane machine 100 is pushed from the approach area onto the lane. The transfer wheels 150 have a conical edge that guides the wheels 150 along the edge of the lane. As shown in FIG. 4, the rear wall of the lane machine 100 comprises support casters 160 for supporting the lane machine 100 in a storage position. To place the lane machine 100 in a storage position, the user folds the handle 130 down into a recess formed in the top cover 120 and raises the lane machine 100 using handle bars 170 in the front wall (see FIG. 6).

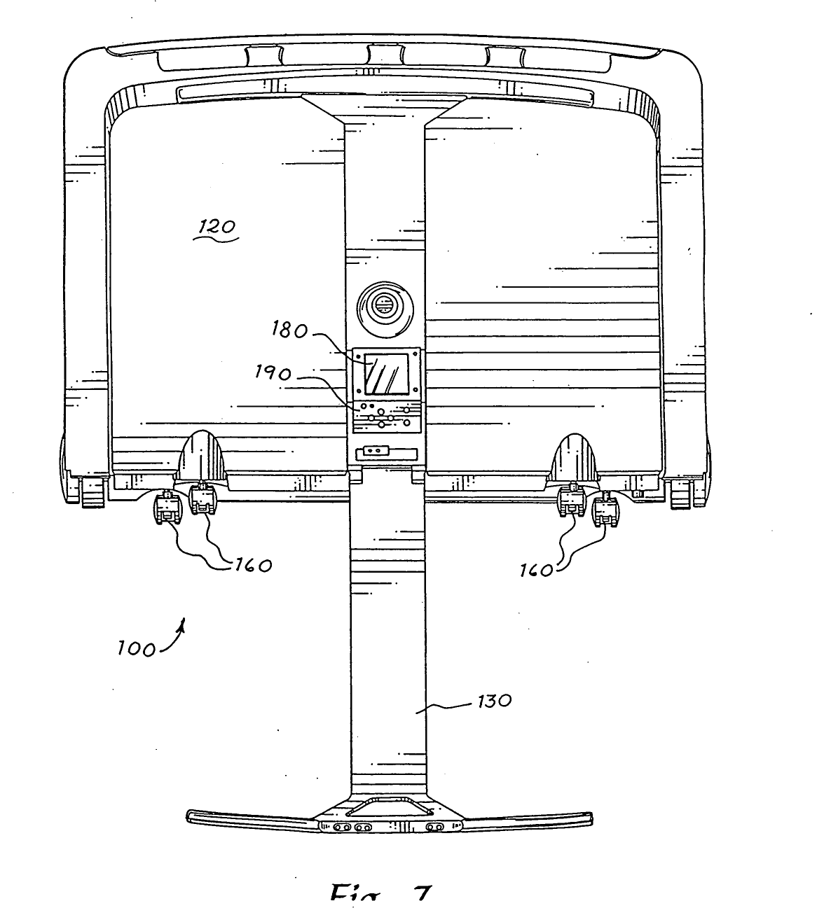

As shown in FIGS. 1 and 7, the lane machine 100 also comprises a display device 180, a first input device 190, and a second input device 200. In this embodiment, the display device 180 and the first input device 190 are located on the housing 110 and are visible through an opening in the top cover 120. The second input device 200 is located on the handle 130. Locating the second input device 200 on the handle 130 places the second input device 200 at the user's fingertips when he is standing next to the lane machine 100. This allows the user to interact with the lane machine 100 without having to stoop over to reach the first input device 190. Other physical layouts are possible. For example, instead of being located on the housing 110, the display device 180 can be located on the handle 130. Also, instead of having two input devices, a single input device can be used (e.g., located on the housing 110 or on the handle 130) or more than two input devices can be used.

In this embodiment, the first and second input devices 190, 200 have the same keys (albeit in a different arrangement) to provide identical functionality irrespective of which input device 190, 200 is being used. In an alternate embodiment, the first and second input device 190, 200 have different keys to provide different functionality. For example, the first input device 190 can have a more extensive keyboard than the second input device 200 to offer a more complex user interface. In one alternate embodiment, the second input device 200 is used for basic feedback and lane change selections, while the first input device 190 is used for diagnostics and pattern setup.

The display device 180 and first and second input devices 190, 200 can take any suitable form. In one presently preferred embodiment, the display device 180 is a color 6.5″ diagonal TFT screen having a 640×480 pixel resolution, and the font displayed on the display device 180 is large enough to read by the user when he is standing behind the handle 130 (of course, more than one font size can be used). In an alternate embodiment, the display device 180 is a text display with little or no graphics capability. As shown in FIGS. 1 and 7, in this embodiment, the first and second input devices 190, 200 each have the same six keys—up arrow, down arrow, left arrow, right arrow, “stop” rectangle, and “ok.” The keys of the second input device 200 are arranged in a linear fashion in this embodiment to fit in a streamline fashion on the handle 130. Of course, one or both of the input devices 190, 200 can take alternate forms. For example, one or both of the input devices 190, 200 can comprise a full-sized QWERTY keyboard, a mouse, one or more switches, a stylus, a touch screen, and/or a microphone for voice recognition. In an alternate embodiment, instead of being located on the lane machine 100, the input device is remotely-located from the lane machine 100, such as when the input device takes the form of a wireless PDA or some other type of standardized or customized hand-held device. Further, while shown as separate devices in this embodiment, the display device 180 and the input device can be integrated, such as when the display device 180 and the first input device 190 are implemented as a touch screen.

The lane machine 100 also comprises a drive system (e.g., a drive motor and drive wheels), a cleaning fluid delivery and removal system, and a lane dressing fluid application system. The drive system automatically propels the lane machine 100 from the foul line to the pin deck and back. In operation, as the lane machine 100 is propelled from the foul line to the end of the lane, the cleaning fluid delivery and removal system cleans dirty, depleted oil off the bowling lane, and the lane dressing fluid application system applies fresh oil to the lane to create a lane dressing fluid pattern. (Instead of performing both cleaning and conditioning operations, the lane machine 100 can be run in a cleaning-only mode or a conditioning-only mode.) When the lane machine 100 reaches the end of the lane, at least some components of the cleaning and conditioning systems are turned off, and the drive system propels the lane machine 100 back to the foul line. In an alternate embodiment, the conditioning system remains on during the return journey to further condition the lane. In another alternate embodiment, the buffer brush remains on during the return journey to improve the appearance of the oil applied to the lane. After the lane machine 100 returns to the foul line, the user uses the handle 130 to pull the lane machine 100 off the lane and onto the approach area.

The term “lane dressing fluid application system” broadly refers to any system that can apply lane dressing fluid to a bowling lane. In a presently preferred embodiment, the lane dressing fluid application system comprises at least one injector comprising at least one opening and a valve. Preferably, the at least one injector is positioned to output lane dressing fluid directly onto the bowling lane as the lane machine 100 moves along the bowling lane. Preferably, 39 injectors are used—one for each board of the lane, although more or fewer injectors can be used. Also, instead of applying lane dressing fluid directly onto the bowling lane, the at least one injector can be positioned to output lane dressing fluid onto a transfer roller in contact with a buffer, wherein the buffer receives lane dressing fluid from the transfer roller and applies the lane dressing fluid onto the bowling lane as the lane machine 100 moves along the bowling lane. Further details regarding the use of an injector in a lane dressing fluid application system are described in “Apparatus and Method for Conditioning a Bowling Lane Using Precision Delivery Injectors,” U.S. patent application Ser. No. 10/934,005, filed Sep. 2, 2004, which is assigned to the assignee of the present invention and is hereby incorporated by reference. While the use of injectors has been described in this embodiment, it should be noted that other types of lane dressing fluid application systems can be used, including, but not limited to, those that use a pulse valve (see U.S. Pat. Nos. 5,679,162 and 5,641,538), a spray nozzle (see U.S. Pat. Nos. 6,090,203; 3,321,331; and 3,217,347), a wick (see U.S. Pat. No. 4,959,884), or a metering pump (see U.S. Pat. Nos. 6,383,290; 5,729,855; and 4,980,815). Each of those patents is hereby incorporated by reference. One advantages of using 39 injectors over these other systems is that a 39-injector system allows a user to independently control the thickness of dressing fluid across the width of a bowling lane within a single board accuracy.

In this preferred embodiment, the lane machine 100 comprises a user interface system that provides a graphic user interface that is both intuitive and user friendly. The user interface comprises the display device 180, the first and second input devices 190, 200, and circuitry in communication with the input devices 190, 200 and the display device 180. “Circuitry” can take any suitable form, including, but not limited to, a general-purpose processor executing computer-executable program code, an application specific integrated circuit, a programmable logic controller, an embedded microcontroller, and a single-board computer. In one embodiment, the circuitry is operative to display a graphical representation on the display device 180 of a lane dressing fluid pattern to be applied to the bowling lane by the lane dressing fluid application system. The circuitry is also operative to receive input from one or both of the input devices 190, 200 indicating a change in the lane dressing fluid pattern to be applied to the bowling lane and dynamically update the graphical representation in response to the input. The circuitry can additionally or alternatively be operative to display a graphical representation on the display device 180 of at least one zone along a longitudinal length of the bowling lane and to dynamically update the graphical representation in response to input from one or both of the input devices 190, 200 for one or more of the following: adding a zone, deleting a zone, and adjusting a length of a zone. Circuitry can additionally or alternatively be used to perform other functions, examples of which are described below.

As used herein, the term “graphical representation” refers to any illustration, graph (e.g., bar, line), map, etc. A “graphical representation” can include text but preferably contains an illustration, graph, map, etc. in addition to text. One-, two-, or three-dimensional graphical representations can be used. As also used herein, the phrase “dynamically update” refers to an update that occurs as individual changes are being made, in contrast to after a plurality of changes have been received, stored in memory, and then processed. While a dynamic update can occur immediately upon receiving an input that triggers the dynamic update, some delay may take place after the input is received (e.g., because of signal propagation delays). As also used herein, a “zone” is an area along the longitudinal length of the bowling lane (i.e., along the length running from the foul line to the pin deck) that has a specific lane dressing fluid pattern. A bowling lane can be divided into one or more zones, with each zone having a respective lane dressing fluid pattern. Multiple zones can have identical or different lane dressing fluid patterns.

The user interface system of this preferred embodiment provides several advantages. As compared to prior lane machine user interfaces, this user interface is intuitive and user-friendly because it is designed around how the user thinks (“I want X units of oil at this location on the bowling lane.”) rather than around machine language (“I want X streams of oil across a lane spread over Y boards at Z speed. In other words, the user only needs to know the desired lane dressing fluid pattern and not how various machine components affect the pattern (e.g., the compound effects of speed, volume, and brush volume). This avoids the trial and error associated with some prior lane machines. Also, because the display device 180 displays a graphical representation of the lane dressing fluid pattern being applied and the location of the zones along the lane, a user can more readily visualize a desired lane dressing fluid pattern than when a simple text readout is used. This graphical representation is easy for a user to understand and modify by manipulating how the pattern looks on the display device 180. Further, dynamically updating the graphical representation of the lane dressing fluid pattern and/or zone layout provides a user with a fast and efficient visual feedback to the changes he is making.

In this presently preferred embodiment, the lane machine 100 comprises two processors—a first processor that controls the lane dressing fluid application system (and possibly other components) and a second processor (i.e., “circuitry”) that is used to provide a graphic user interface. The first and second processors are preferably arranged in a server-client relationship. The first processor acts as the server, having memory so it can work independently of the client (the second processor) until it receives instructions from the client. This server-client arrangement has the advantage that the graphic user interface system can be updated with a newer processor (CPU) without changing the first processor. This is particularly advantageous if the second processor is an off-the-shelf consumer electronics device, which is quick to become obsolete as technology introduces new units with better features and lower cost, and the first processor has a longer life span before it becomes obsolete (e.g., ten years). In addition to being less susceptible to obsolescence, the first processor is also preferably more rugged that the second processor (e.g., is less susceptible to temperature, shock, and vibration). The first processor is preferably able to withstand temperatures from about 0-70° C. and is able to withstand as much shock and vibration as other components on a printed circuit board because there are no moving parts, such as a hard drive. By being more rugged, the first processor allows the lane machine 100 to operate even if the second processor fails (assuming there is some mechanism to initiate the first processor). (As noted below, the first processor can receive input from an optional keyboard and provide output to an optional display device so a user can control the first processor even if the second processor fails.) In short, while the first processor is more reliable for machine control, it may not have the capability to provide an easy-to-use user interface. The second processor provides the user interface and allows for consumer upgrades.

In this embodiment, the second processor, the display device 180, and the first input device 190 are packaged together in a single unit that is removable from the housing. Preferably, the single unit is provided with the lane machine 100, which eliminates the need for users to purchase additional equipment that may not be readily available to them. Because the single unit can be removed from the housing, the processor in the unit can be easily removed and replaced with an updated processor. In this embodiment, the processor in the single unit functions as a dedicated, single-purpose computer. This is in contrast to a conventional personal computer (PC) or notebook computer, which can be used to perform general purpose functions, such as word processing, email, games, etc. Preferably, the processor is capable of being operated when the single unit is removed from the housing (an additional power supply may be needed, or the single unit can comprise a battery). In this way, a user can program new lane patterns into the single unit or change lane patterns that are already stored in the single unit (the single unit retains its programming when removed from the housing) at any desired location.

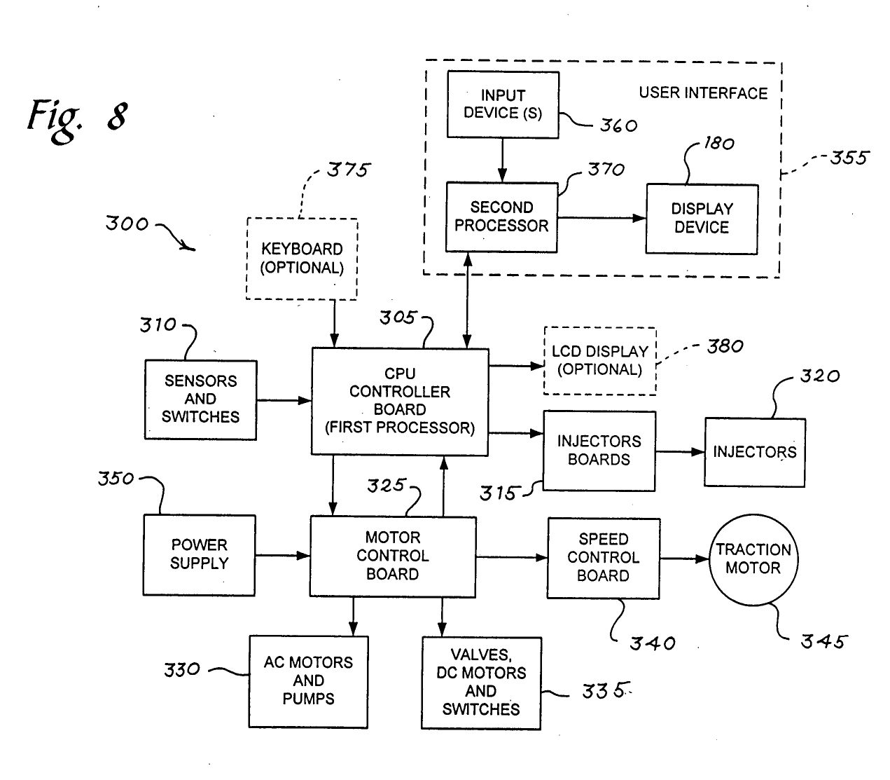

Turning again to the drawings, FIG. 8 is a block diagram of a control system 300 of the lane machine 100. As shown in FIG. 8, the control system 300 comprises a CPU controller board 305 (containing the first processor), which preferably contains an embedded microcontroller, flash memory, an analog-to-digital converter, SRAM memory, and an EPROM and preferably operates using firmware using C-language or assembler language. The CPU controller board 305 receives input from sensors and switches 310 to determine the status of the lane machine 100 during operation. In this embodiment, one of these input sensors 310 indicates the speed and position of the lane machine 100 on the bowling lane (distance from the foul line). Based on this input, the CPU controller board 305 sends an injector pulse duration to five injector driver boards 315 to control the amount of oil that each of the 39 individual injectors 320 applies at every 0.1 foot increment (or some other increment) down the lane. In this embodiment, each injector driver board 315 controls the power to control the pulse of eight injectors.

The CPU controller board 305 also communicates with a motor control board 325. The motor control board 325 controls all other output devices other than the injectors. Examples of these output devices include AC motors and pumps 330 (which can control a buffer brush, dispersion roller, vacuum, and pump motors) and valves, DC motors, and switches 335 (which control DC lift gear motors and solenoid valves to control the cleaner and conditioner pressures). The motor control board 325 also provides output to a speed control board 340, which further conditions the acceleration and speed control for a DC traction motor 345. In this control system 100, a DC power supply 350 provides 12VDC to the CPU controller board 305, 12VDC to the motor control board 325, and 12VDC to the injector driver boards 315. The CPU controller board 305 can receive input from an optional keyboard 375 and provide output to an optional LCD text display 380. The optional keyboard 375 and display 380 can be used to control all lane machine 100 inputs and outputs to clean and condition the lane with no other CPU. The optional keyboard 375 and display 380 can be used on lower-cost machines instead of a user interface system 355 and can also be used as a backup device on higher-end systems having a user interface system 355.

In this preferred embodiment, the CPU controller board 305 is in communication with a user interface system 355, which provides the interface between the user and the CPU controller board 305. As used herein, one element is “in communication with” another element through a wired or wireless medium. Also, two elements are “in communication with” each other even when the communication passes through one or more intermediary elements. For example, the user interface system 375 is in communication with the lane dressing application system (i.e., the injector boards 315 and injectors 320) through the CPU controller board 305.

The user interface system 355 provides a way for the user to access the lane machine's settings and options and comprises the display device 180, input device(s) 360, and a second processor 370. The input device(s) 360 in this embodiment take the form of the first and second input devices 190, 200. Preferably, the second processor 370 comprises a single-board computer operating on a Linux operating system. Also, the second processor 370 preferably contains memory and a driver to display text and graphics on the display device 180. Preferably, the second processor 370, the display device 180, and the first input device 190 are packaged so that they can easily be removed from the lane machine 100 to allow convenient programming from any location. The second processor 370 also preferably contains USB and serial inputs to allow connection to an external laptop or PC-based computer, a memory device (such as a Flash card), an Ethernet or other type of network connection, a wireless communication device, or a modem for software updates and for importing/exporting data. For example, by connecting the second processor 370 to a network (e.g., the Internet), a user can download and share oil patterns and logs, as described below.

The second processor 370 receives operator input from the first and second input devices 190, 200, which, in this embodiment are used to navigate through menus of a graphic user interface displayed on the display device 180. Preferably, the graphic user interface requires as few keystrokes as possible to make the interface easy to user. In operation, when a user gives a command via the input device(s) 360 (e.g., to increase/decrease an amount of oil to be applied or add, remove, or adjust the length of a zone), the second processor 370 sends an instruction to the CPU controller board 305 in accordance with the input. The CPU controller board 305 carries out the instruction by sending the appropriate commands to the five injector driver boards 315 to control the amount of oil that each of the 39 individual injectors 320 applies down the lane.

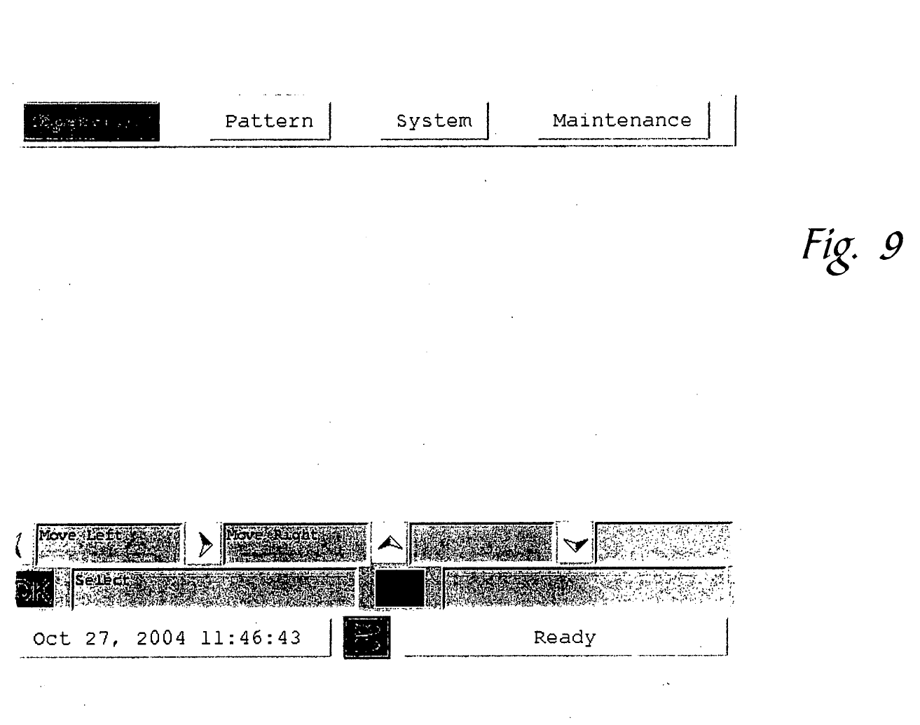

Returning again to the drawings, FIGS. 9-47 are illustrations of displays of the user interface system 355. FIG. 9 is an illustration of the starting menu in the “setup mode” of the user interface. The top of the screen contains four menu choices: operator, pattern, system, and maintenance, and the bottom of the screen contains a legend informing the user of the functions of the six buttons on the first and second keypads 190, 200. To navigate through the menu choices, the user presses the left and right arrow buttons to highlight a desired menu choice and presses the ok button to select the highlighted choice. Different colors are used to show the current location of the cursor and the path in which the menu was entered. For example, in these embodiments, blue is used to designate the menu option for the presently-displayed screen, and red is used to designate the menu option for the screen displayed prior to the presently-displayed screen. While color was used in this example, the other techniques can be used to display the menu option for the presently-displayed screen differently from the menu option for the screen displayed prior to the presently-displayed screen (e.g., the use of different shadows, fonts, font sizes, hatchings, etc.). One or more of these menu choices can be protected with a security feature, such as requiring a PIN entry.

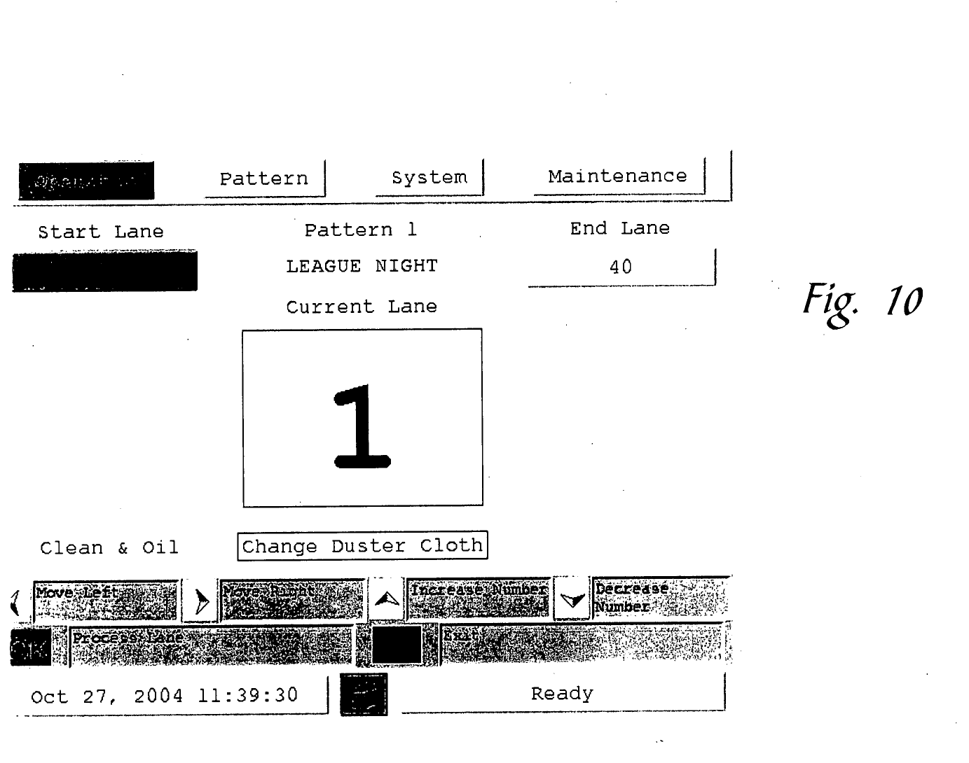

FIG. 10 is an illustration of a display shown when the operator menu is selected. The display indicates the pattern number and pattern name (here, “LEAGUE NIGHT”) and allows the user to change the starting and ending lane to which the indicated pattern is applied. This menu also allows a user to designate the current lane, which is useful when a lane has been skipped, e.g., when a bowler occupies a lane between the start and end lanes. If the user skips a lane, the user interface preferable returns to the skipped lane after the end lane has finished being processed. This menu also allows a user to choose various cleaning/oiling modes for a particular pattern and provides the user with the option of informing the lane machine 100 that the duster cloth has been changed and/or to prompt the user to change the duster cloth. As indicated by the legend at the bottom of the screen, the user interacts with this section by moving a highlighted box with the left and right arrow keys to indicate a field to be changed and increases and decreases the indicated numbers by pressing the up and down arrow keys, respectively.

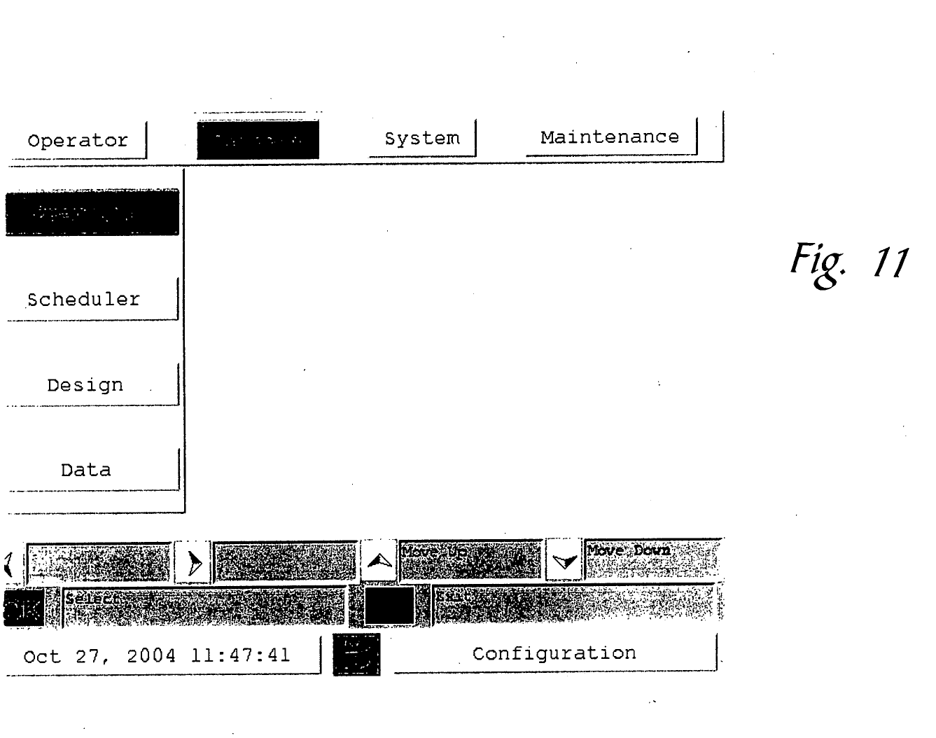

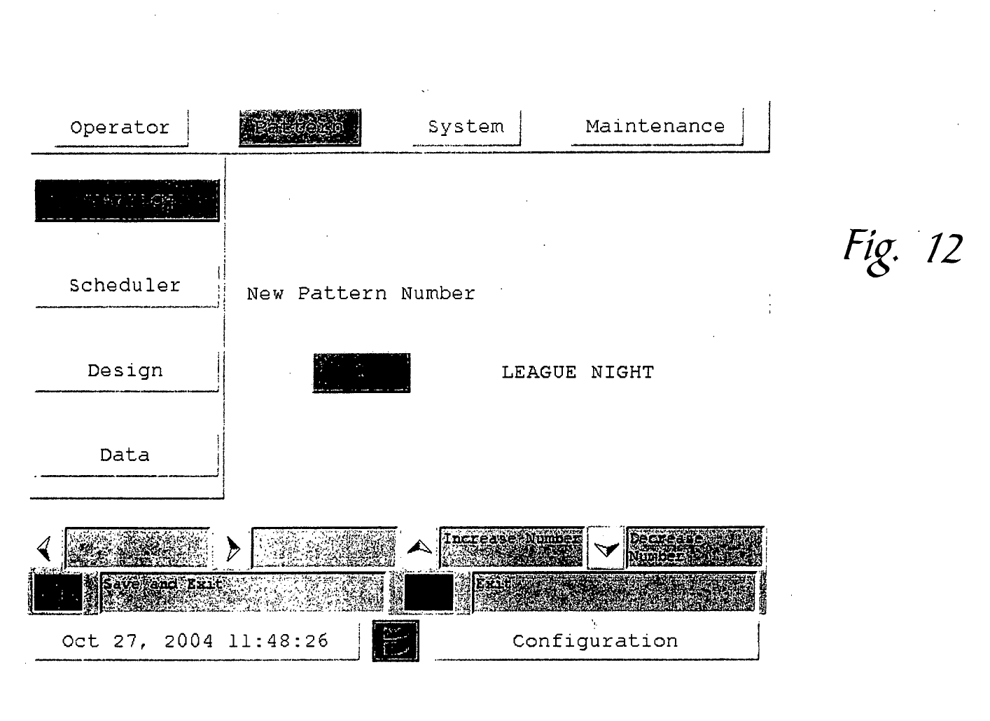

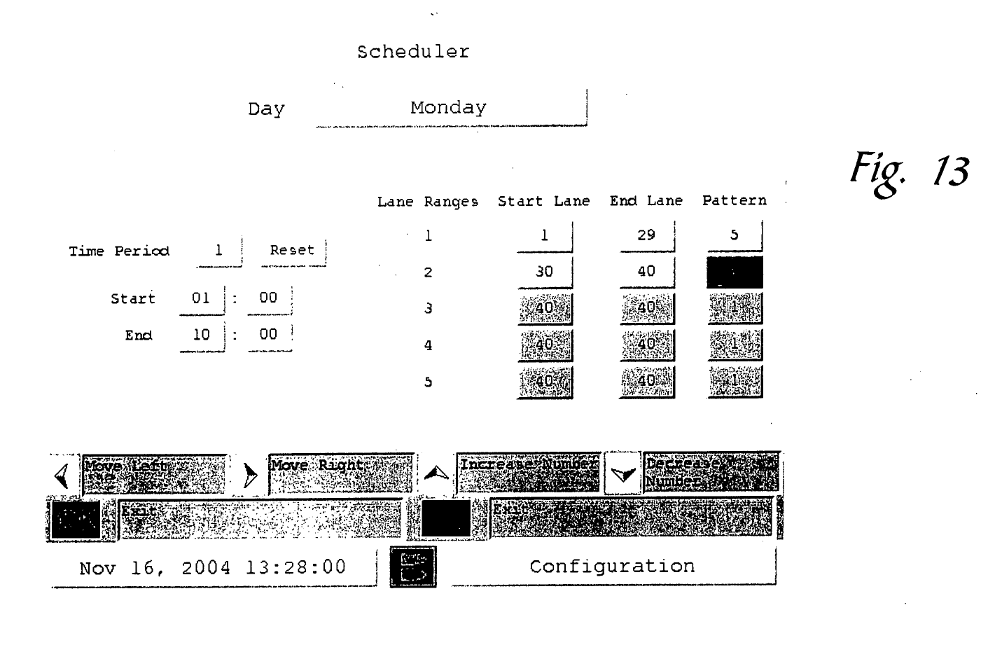

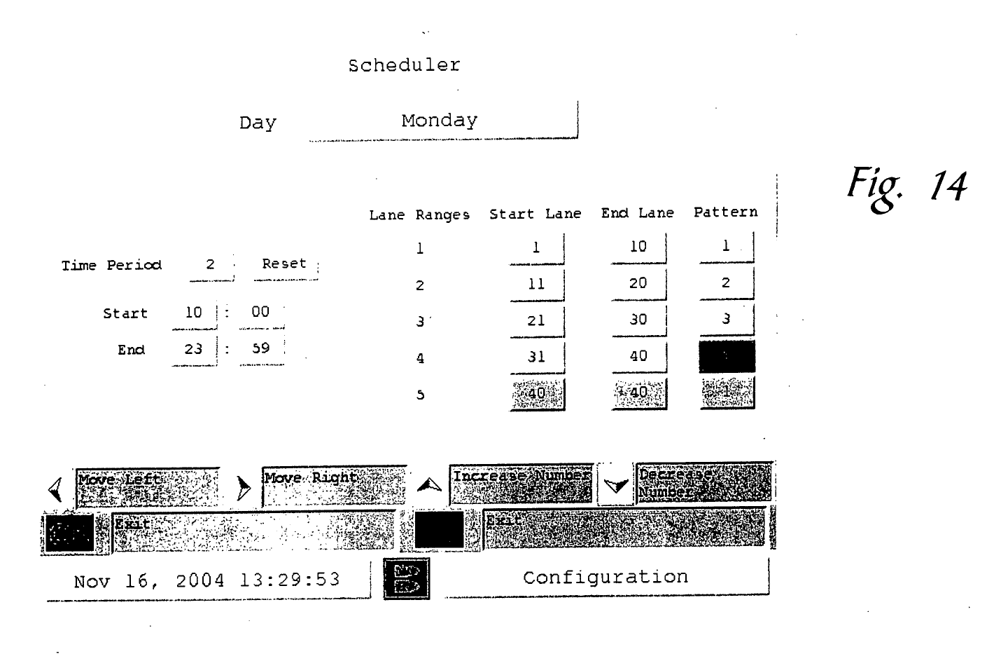

If the user selects the pattern menu in FIG. 9, a sub-menu appears listing four additional choices: override, scheduler, design, and data (see FIG. 11). If the user selects the override menu, a new screen appears (FIG. 12) allowing the user to select a new pattern by increasing or decreasing a pattern number. The name associated with that pattern is also displayed. If the user selects the scheduler menu, a new screen appears allowing the user to schedule which pattern to apply to which lane on certain times during a day. For example, as shown in FIG. 13, from 1:00 to 10:00 on Mondays, pattern 5 is applied to lanes 1-29, while pattern 1 is applied to lanes 30-40. As shown in FIG. 14, a different set of patterns for a different set of lanes is used for the rest of the day (10:00-23:59).

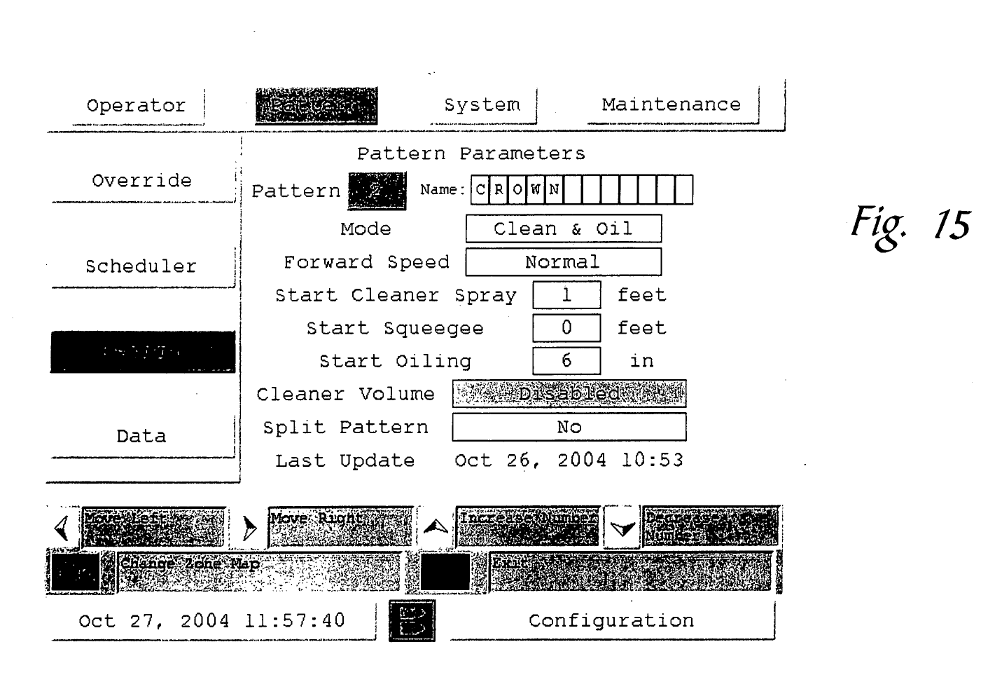

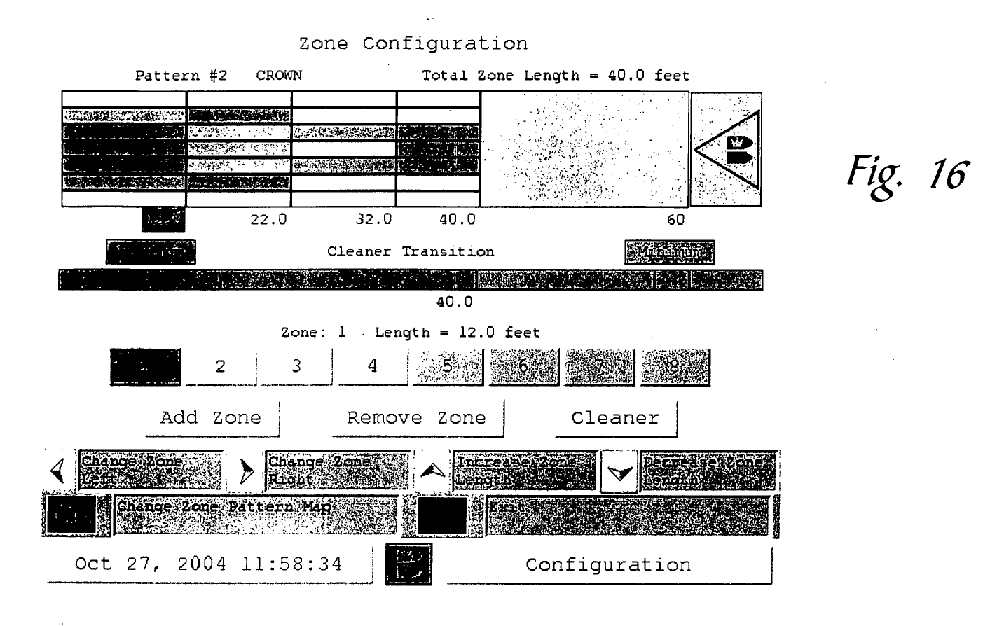

FIGS. 15-26 illustrate the pattern design menu. FIG. 15 is the first screen (pattern parameters) in this menu and indicates the pattern number and name. This menu allows the user to change the following parameters: mode, forward speed, start cleaner spray, start squeegee, start oiling, cleaner volume, and split pattern. As indicated by the legend at the bottom of the screen, the user can change the zone map by pressing the ok button. FIG. 16 (zone configuration) is an illustration of a zone map. This map is a graphical representation of a bowling lane, starting at the foul line and ending at the end of the pin deck, which is typically 60 feet from the foul line. In this particular configuration, there are four zones, and the screen indicates where each zone begins and ends on the lane. There are 39 boards in a typical bowling lane, each with a width of 1 1/16″, and the graphical representation of the zones have the 39 boards arranged in seven groups: 1-6, 7-12, 13-17, 18-22, 23-27, 28-33, and 34-39. The color in each group of boards is related to the amount of oil to be applied in that group.

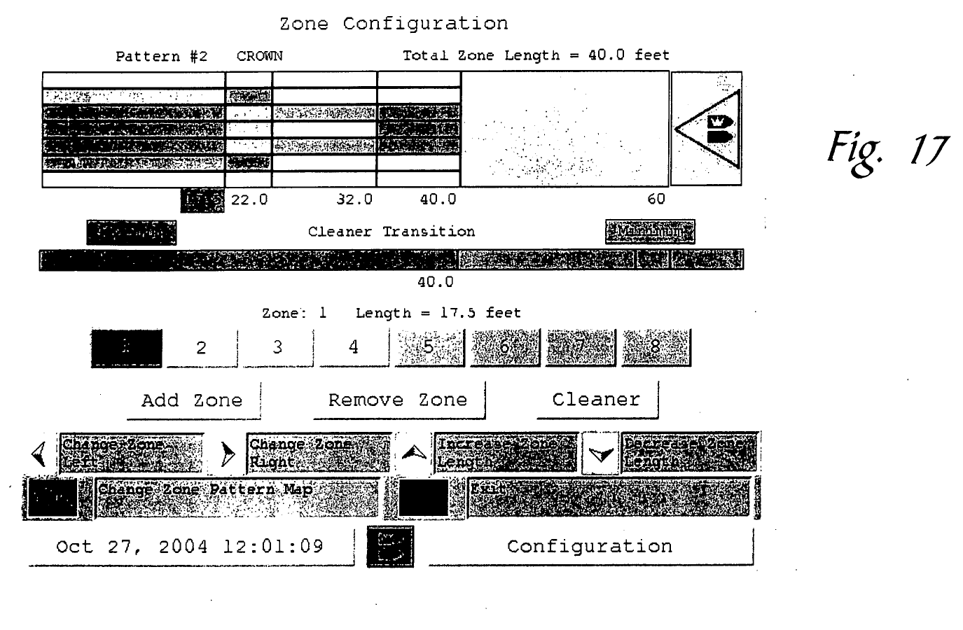

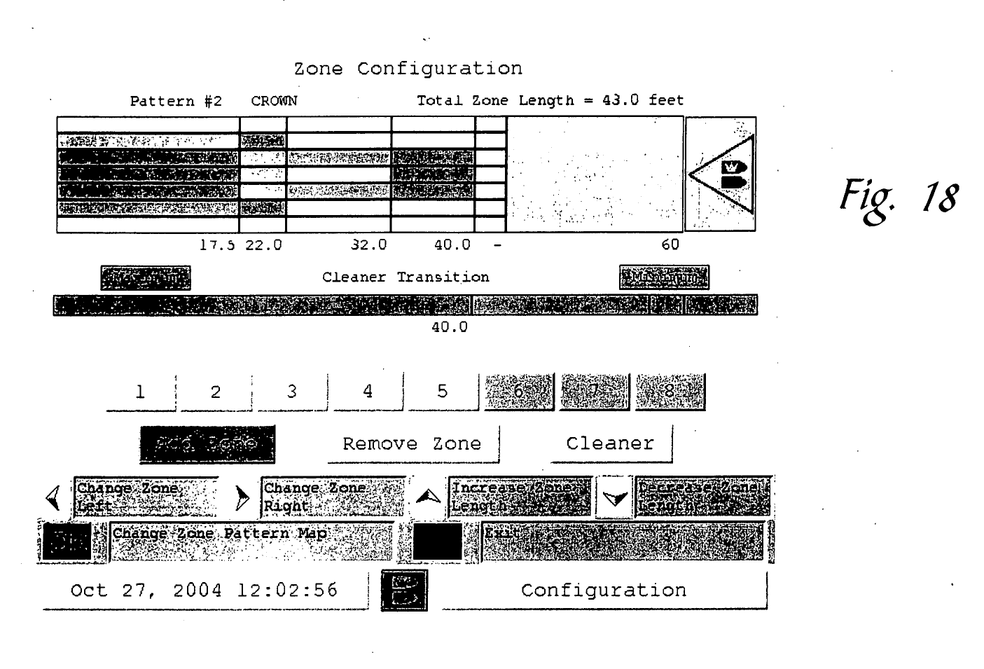

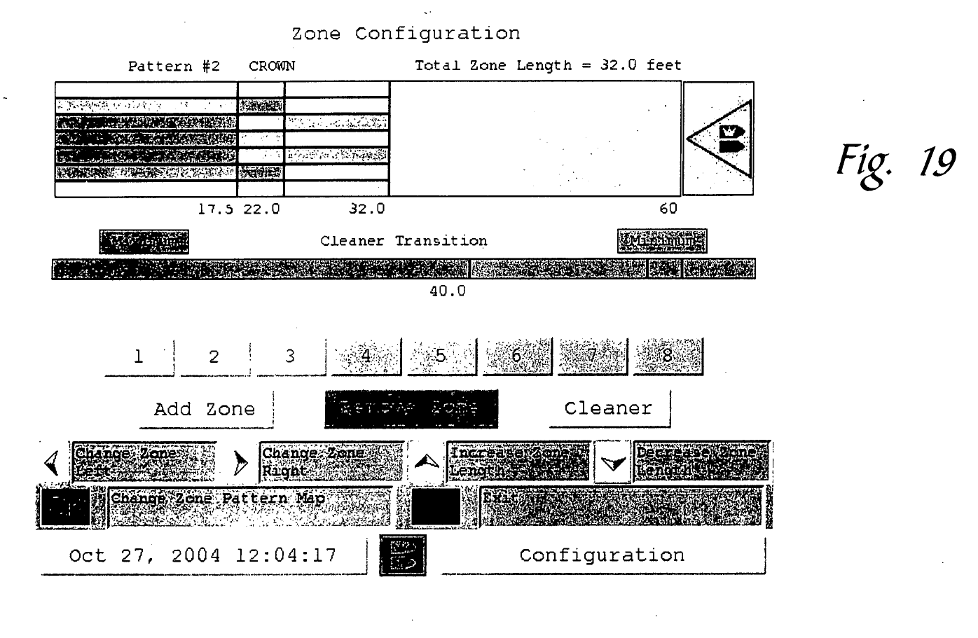

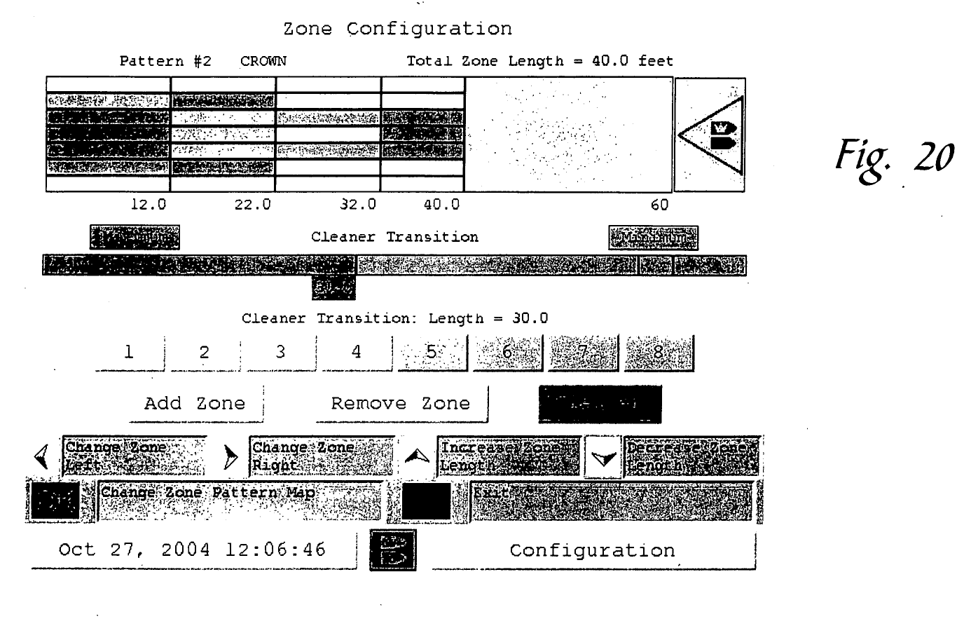

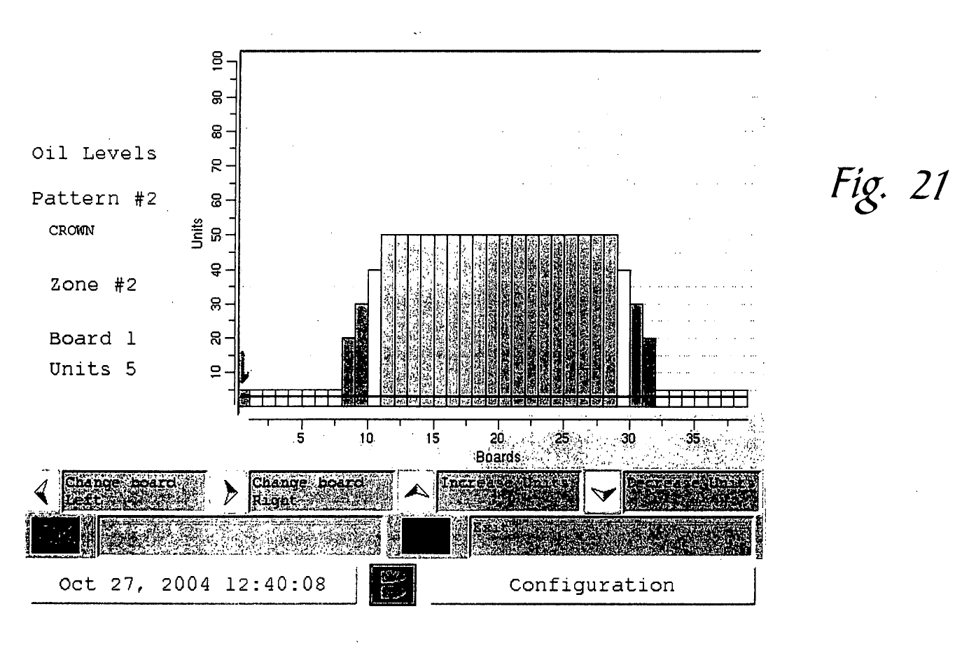

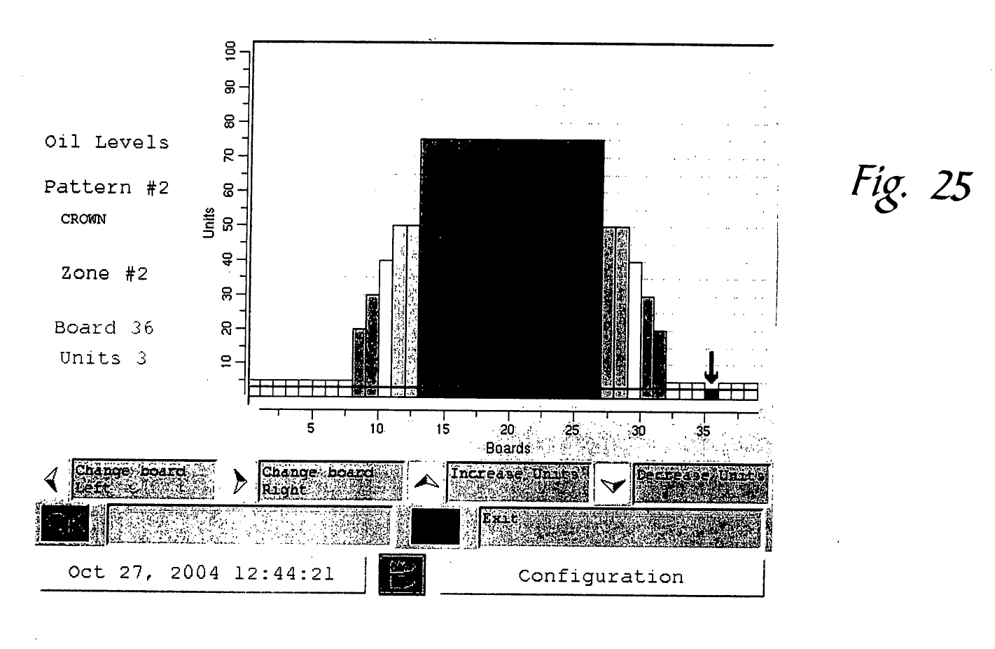

In this screen, the user has the option to adjust the length of a zone, add a zone, and remove a zone. To adjust the length of a zone, the user moves the highlighted box over the zone whose length he wishes to adjust and then presses the up and down arrows to increase and decrease, respectively, the length of the selected zone. FIG. 17 shows the display after the user has increased the length of Zone 1 from 12.0 feet to 17.5 feet. To add a zone, the user moves the highlighted box over “add zone” and presses the ok button. The result is illustrated in FIG. 18, which shows a new zone (Zone 5) added to the right of Zone 4. Using the functionality described above, the user can increase or decrease the length of this newly-added zone. The user can also remove a zone by moving the highlighted box over “remove zone” and pressing the ok button. FIG. 19 shows the result of removing Zone 4. As illustrated in these examples, the graphical representation of the zone is dynamically updated in response to the input. The user can also select where along the lane he wishes to make the transition from a maximum to a minimum amount of cleaner to be applied to the lane. FIG. 20 shows a screen after a user had moved the cleaner transition from 40.0 feet to 30.0 feet. When the highlighted box is over a zone number, the user can press the ok button to change the oil pattern to be applied in that zone (the “zone pattern map”). FIG. 21 is an illustration of the oil pattern in Zone 2. This screen shows a graphical representation of each of the 39 boards of the bowling lane and colored vertical bars indicate the amount of oil to be applied to each of the boards in this zone. In this embodiment, the amount of oil is indicated by “units” of oil. A “unit” of oil is defined by the American Bowling Congress (ABC) and Women's International Bowling Congress (WIBC) as 0.0167 ml of oil evenly spread over a 1 sq. ft. surface, which equates to a film of oil about 7 millionths of an inch thick. ABC and WIBC require that a minimum of three units of oil be applied across the entire width of the bowling lane to whatever distance the user decides to condition the lane. The horizontal red line across the graph represents this three unit minimum. (As shown in FIG. 25, in this embodiment, the horizontal red line acts as a warning to a user not to reduce the amount of oil on a board less than the three unit minimum.) While “units” of oil are used to illustrate this embodiment, other measures of amounts of oil can be used.

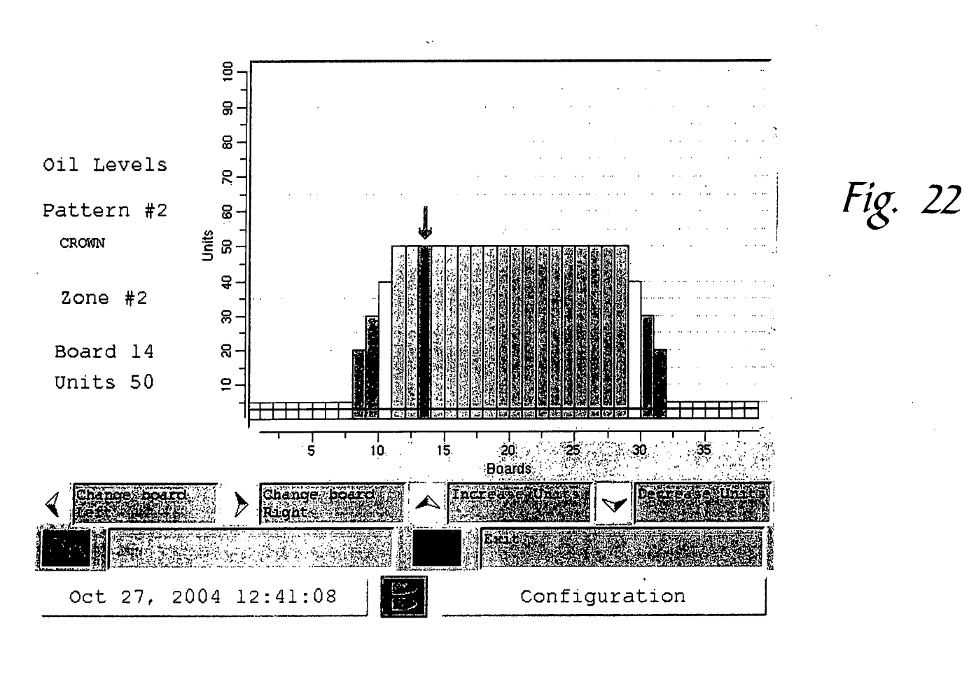

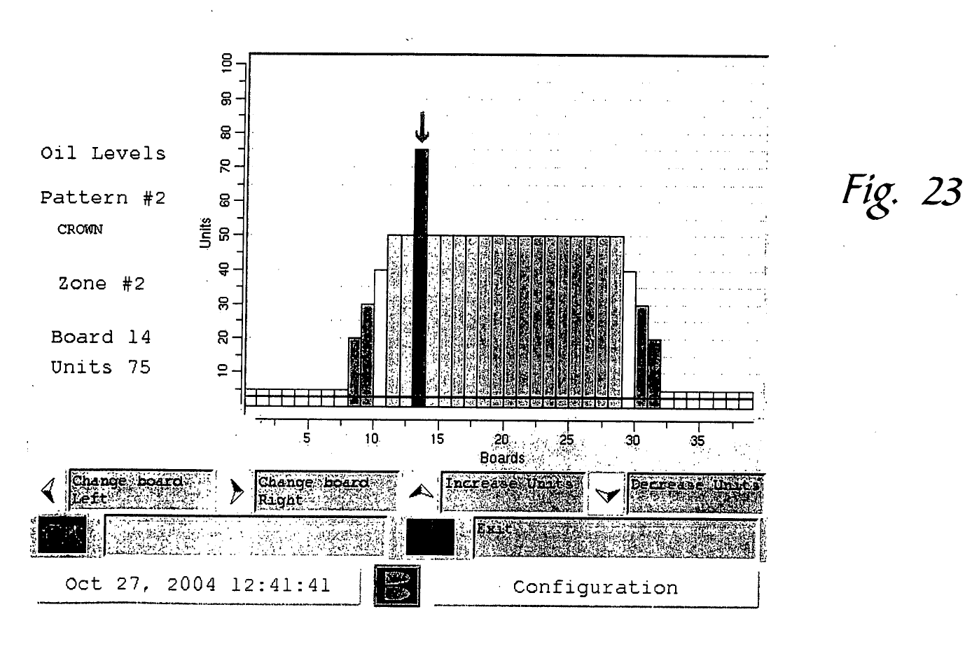

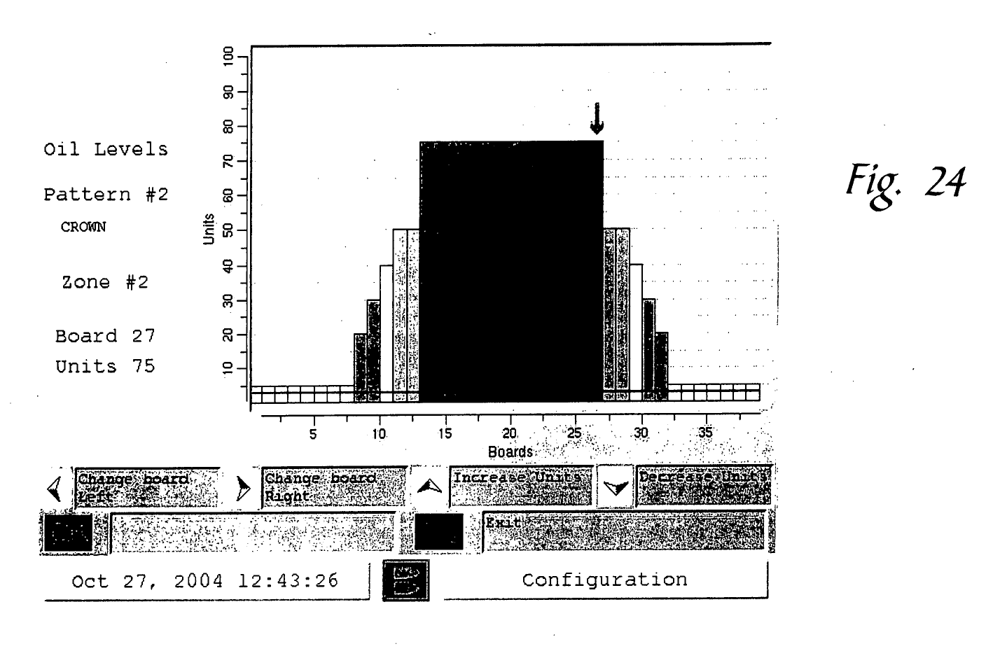

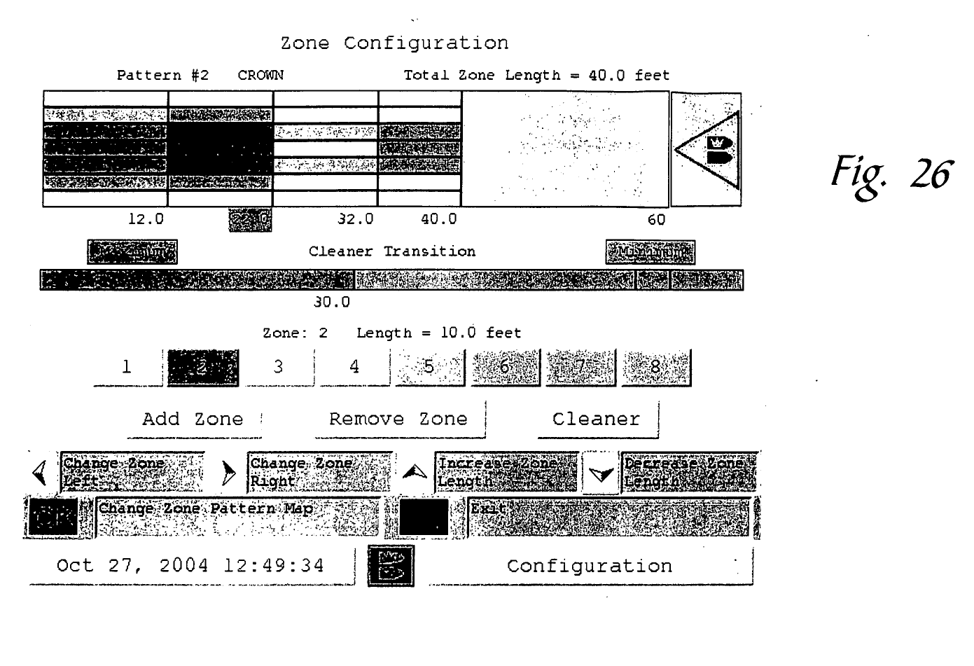

Referring again to FIG. 21, an arrow indicates a currently-selected board. Assume that a user wishes to change the amount of oil on boards 14-27 to 75 units each. The user uses the right arrow button to move the arrow from board 1 to board 14, as shown in FIG. 22. (Although the zone map shows seven groups of boards, in this embodiment, the user is allowed to adjust the amount of oil to be applied to an individual board.) Then, the user uses the up arrow to increase the amount of oil from 50 units to 75 units, as shown in FIG. 23. As with adding, removing, or adjusting the length of a zone, the graphical representation of the oil pattern in this zone is dynamically updated as the user presses the up and down arrows to indicate a change in the amount of oil to be applied to the board. The user continues to select a board and increase the amount of oil to be applied until all the changes are made, as shown in FIG. 24. Pressing the exit button returns the user to the zone map. As shown in FIG. 26, the color of the zone map in the middle of the lane has changed from orange to a darker color in accordance with the changes made to the underlying pattern. The boards in the zone are grouped to show the average oil volume across several boards. Specifically, there are seven groups for the 39 boards: 1-6, 7-12, 13-17, 18-22, 23-27, 28-33, and 34-39. Of course, other grouping can be used, or 39 individual boards can be shown in the zone map.

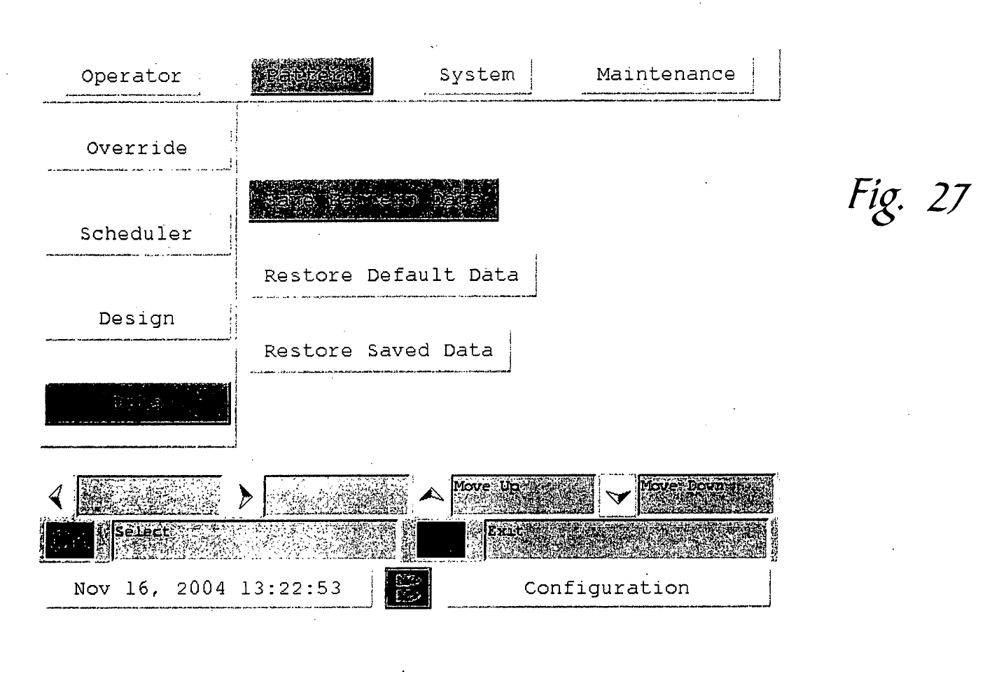

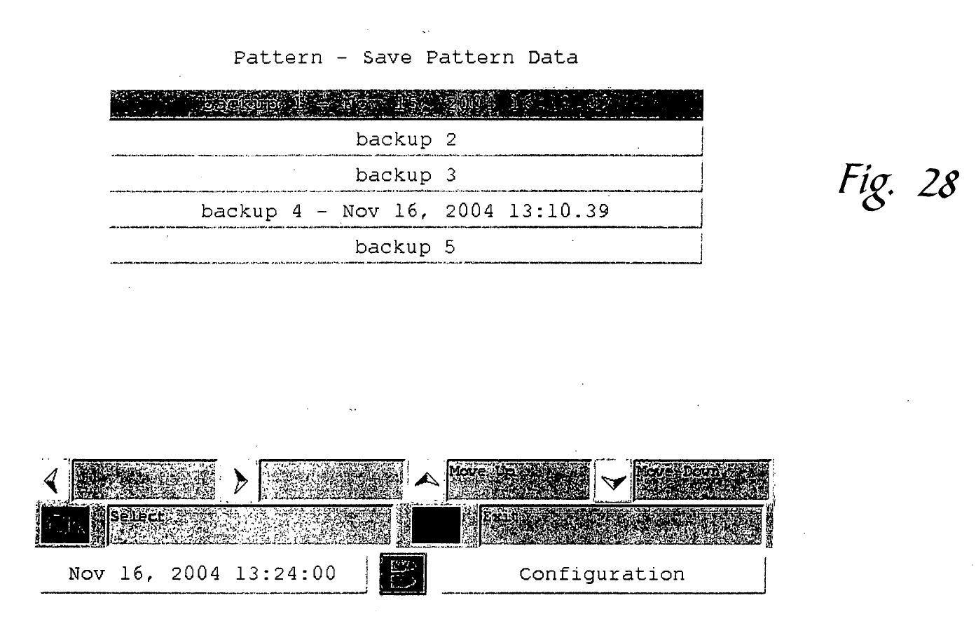

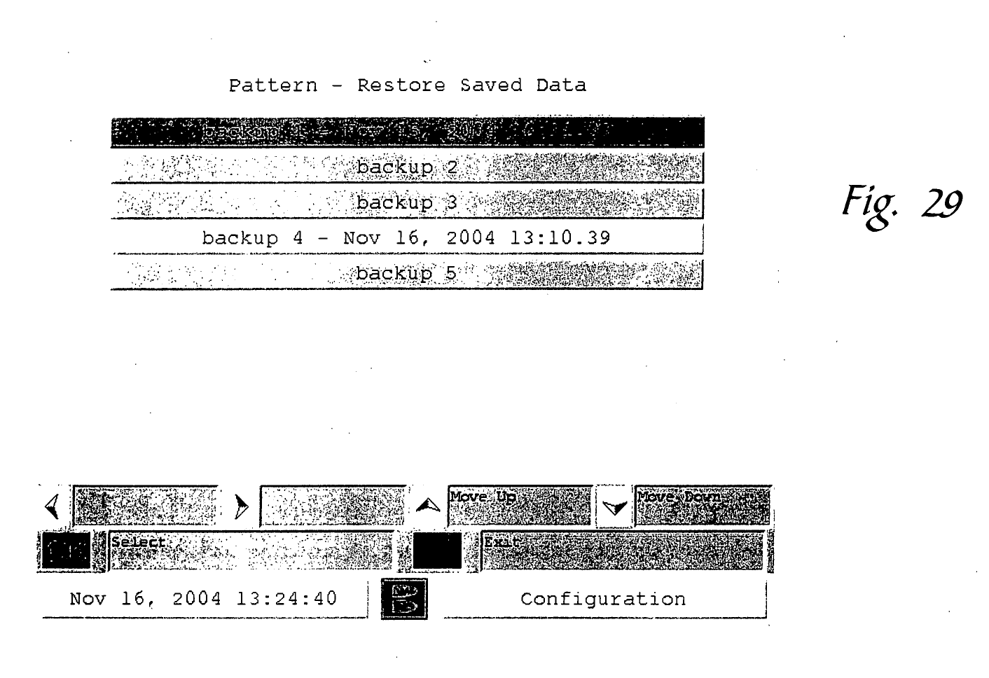

Returning back to FIG. 9, if the user selects the system menu, the screen illustrated in FIG. 27 appears. This screen presents three options: save pattern data, restore default data, and restore saved data. If the used selects the save pattern data option, the screen shown in FIG. 28 appears. This screen allows the user to save data in one of five backup areas and indicates the time and date of a backup. Returning to FIG. 27, if the user selects the restore default data option, the lane machine is restored with default data. If the user selects the restore saved data option, the screen shown in FIG. 29 appears, and the user can select one of five stored pattern data to restore.

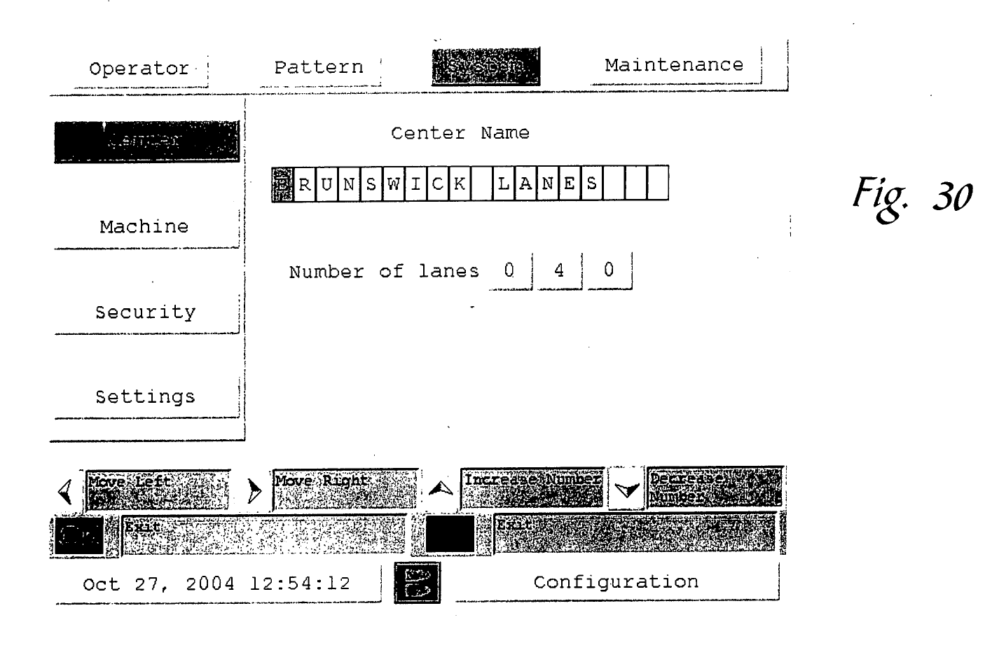

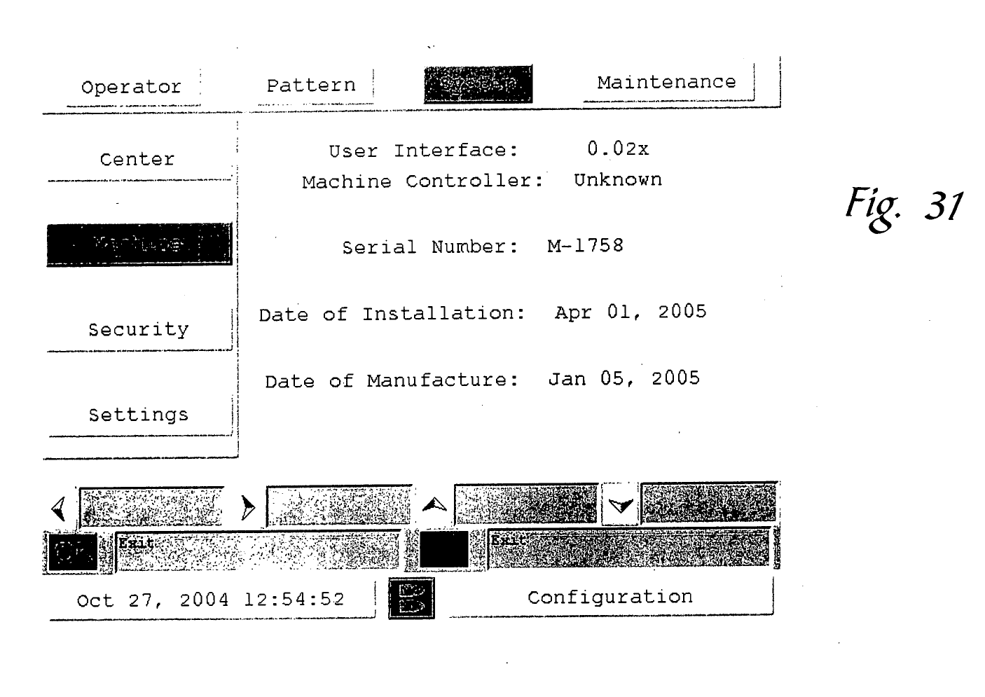

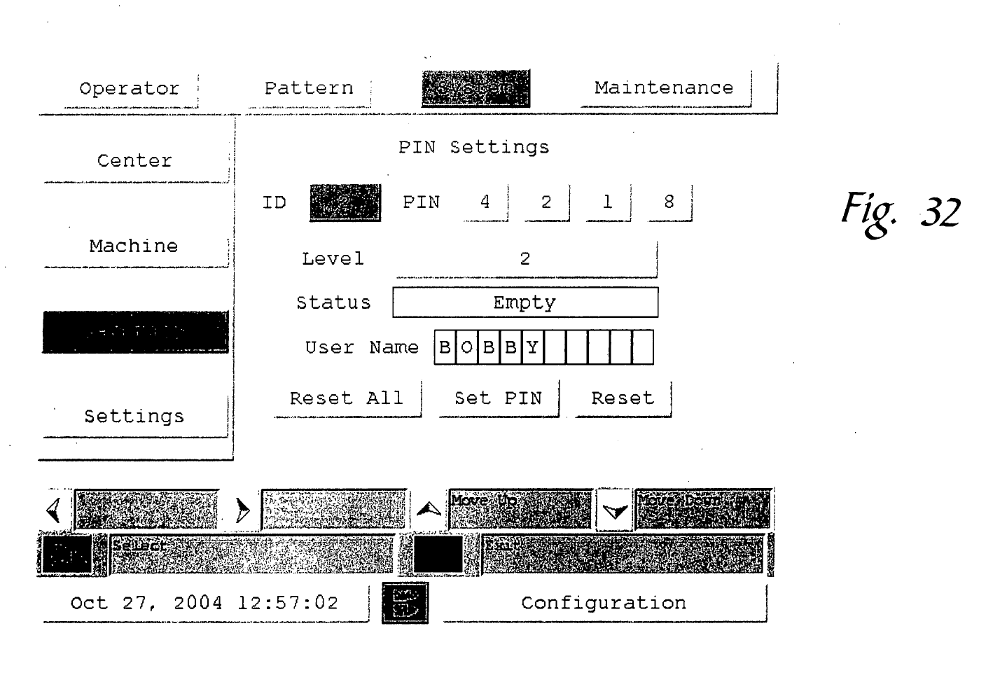

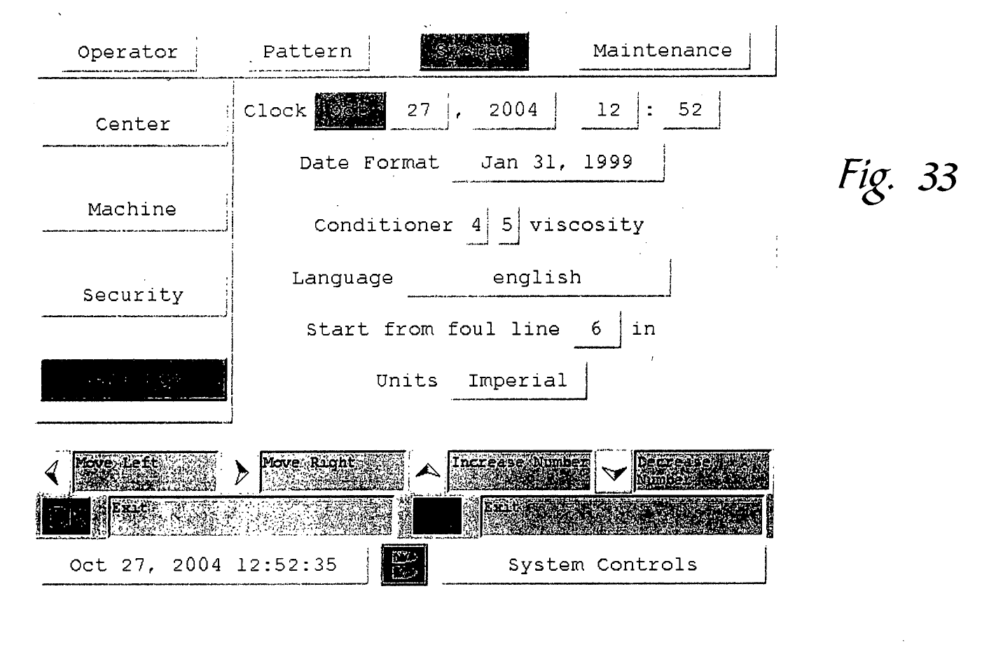

Returning back to FIG. 9, if the user selects the system menu, a screen appears with four sub-menus: center, machine, security, and settings. In the center sub-menu (FIG. 30), the user can designate the name of the bowling center and set the number of lanes in the center. The machine sub-menu (FIG. 31) shows information about the machine, such as user interface number, machine controller, serial number, and dates of installation and manufacture. The security sub-menu (FIG. 32) allows the user to set PINs for multiple users, and the settings sub-menu (FIG. 33) allows the user to set the machine's clock and data format, the viscosity of the conditioner, language, the distance from the foul line where the machine 100 starts the cleaning and conditioning operations, and the measurement system. Selecting the language option causes the text fields on the user interface display to switch to a selected language without the need to restart the software program. This is accomplished by providing the text translation for each language option in a separate memory file. The desired language is dynamically updated as soon as the options in the settings sub-menu (FIG. 33) are entered. Preferably, the font for the text and number fields will change based on Unicode standards that are specified for each language. This feature would allow different operators at the same center to select the language of their choice without wasting time or risking misinterpretation of a less familiar language.

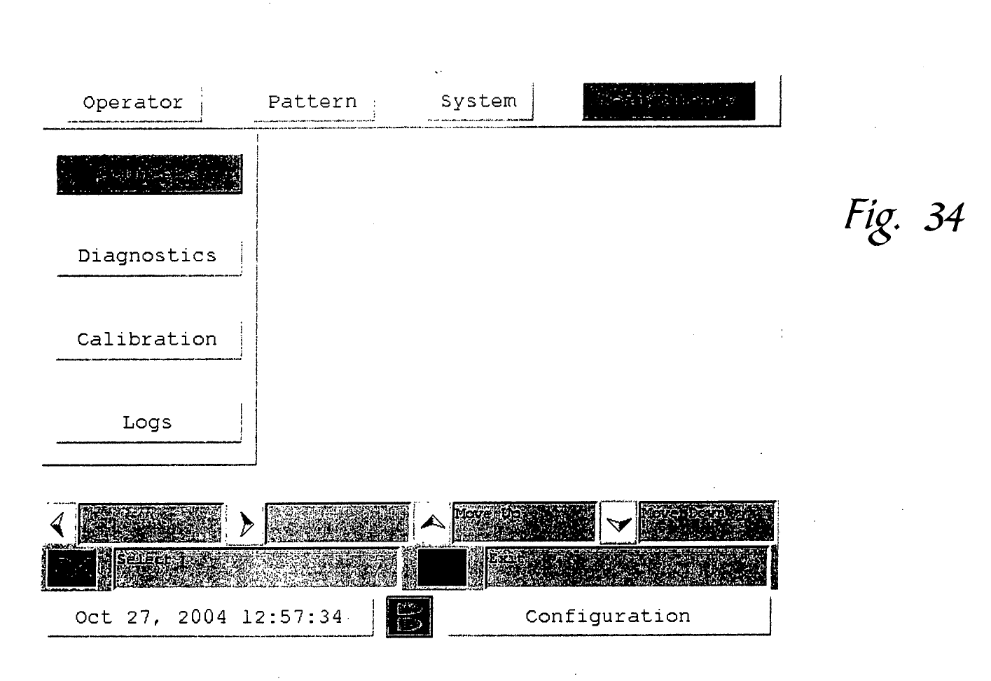

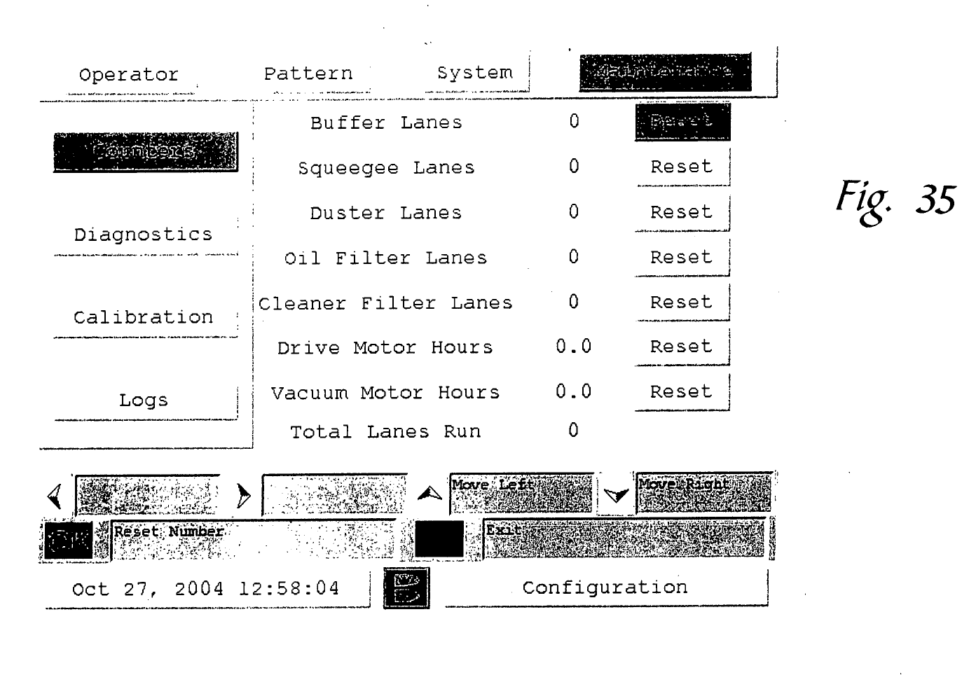

Returning back to FIG. 9, if the user selects the maintenance menu, the display in FIG. 34 appears. The maintenance menu has four-menus: counters, diagnostics, calibration, and logs. The counters menu (FIG. 35) keeps track of the number of lanes run since the last reset for a variety of components. This menu allows a manager or technician to reset the counters after the buffer, squeegee, duster, oil filter, or cleaner filter has been replaced or upgraded. This menu also shows the number of drive and vacuum motor hours, as well as the total lanes run.

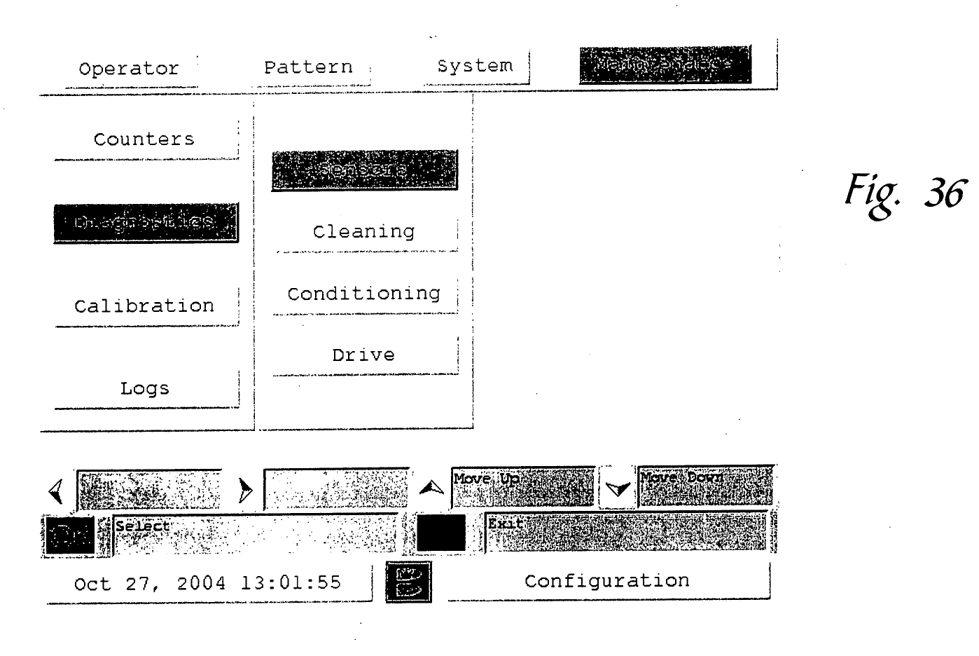

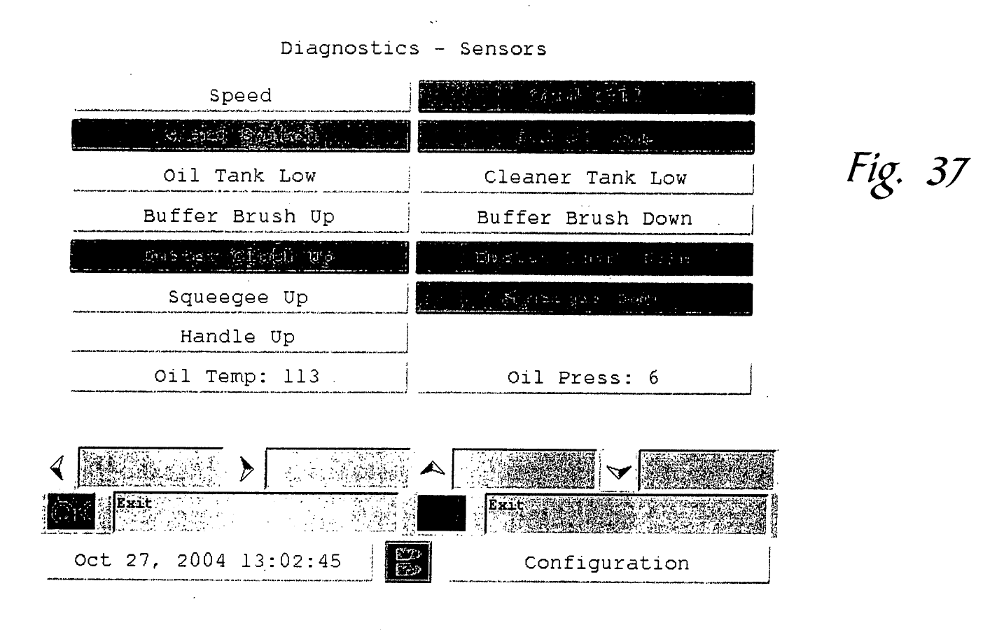

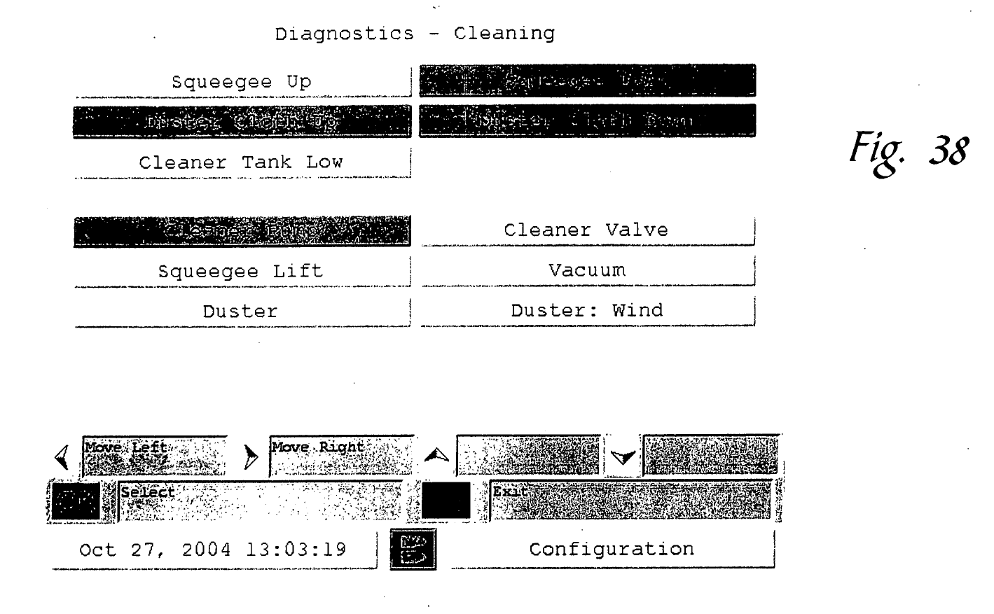

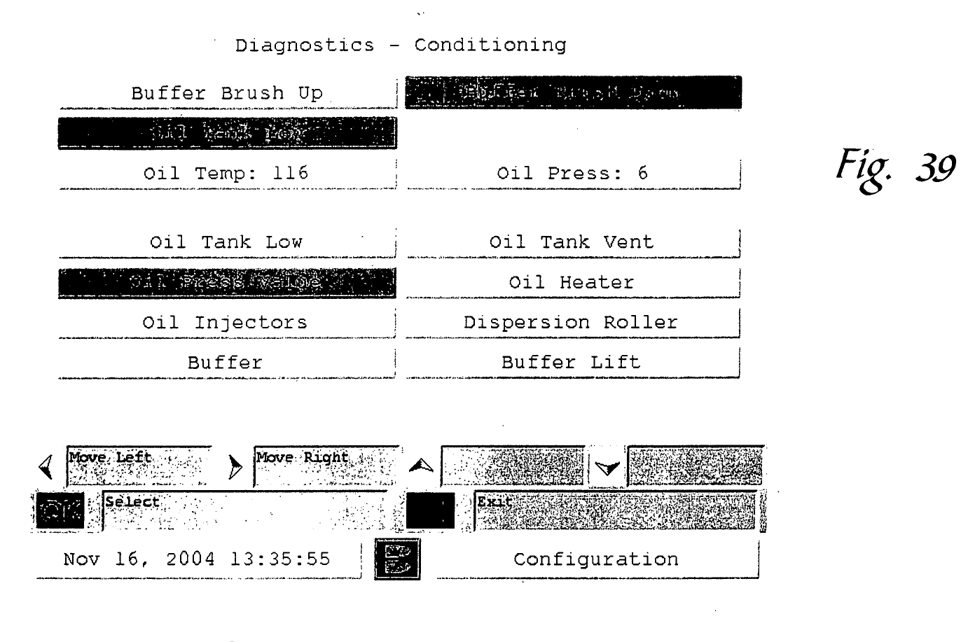

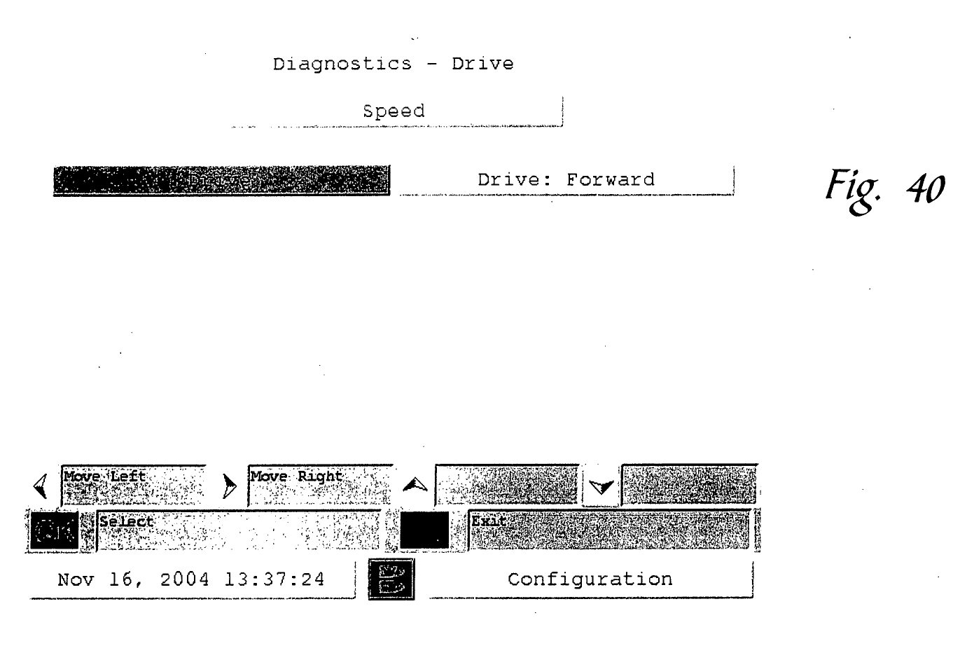

The diagnostics menu (FIG. 36) has four sub-menus: sensors, cleaning, conditioning, and drive. The sensors sub-menu (FIG. 37) shows the current state of various available hardware devices, with the green indicating that the specified sensor is activated. This gives the current status (activated or de-activated) of each of the listed components. The cleaning sub-menu (FIG. 38) shows two sets of boxes (or display regions). The top set of boxes lists a series of cleaning sensors, with green indicating the sensor is activated. The bottom set of boxes allows the user to activate various cleaning components to see if the result of the activation is as expected. In this way, one set of display regions (the bottom set of boxes) indicates which components of the lane machine a user can request activation of, and another set of display regions (the top set of boxes) indicate confirmation that a requested component completed a desired function. For example, the user can select the squeegee lift box, which would lift the squeegee, and then observe whether or not the squeegee up box turns green, indicating that the squeegee was completely raised to the up position. As another example, the user can select the vacuum box to turn on the vacuum motor. The user would verify the output is as expected when he hears the motor running (here, nothing would be displayed in the top set of boxes). The conditioning sub-menu (FIG. 39) contains similar functionality. In this way, a user can request activation of a component of the lane dressing fluid application system and/or the cleaning fluid delivery and removal system (e.g., squeegee lift motor), and the circuitry of the lane machine can display a confirmation on the display device that the component completed a desired function (e.g., the squeegee lift motor completely raised the squeegee to the up position). Although a squeegee lift motor was used in this example, this diagnostics functionality can be used for any component of the lane machine to display confirmation that the selected component completed a desired function. For example, the component can be part of the lane dressing fluid application system, part of the cleaning fluid delivery and removal system, a drive motor, an end-of-lane sensor, or a speed sensor. The drive sub-menu (FIG. 40) allows the user to toggle between driving the lane machine in the forward and reverse directions and to activate the drive motor to ensure the motor is working properly.

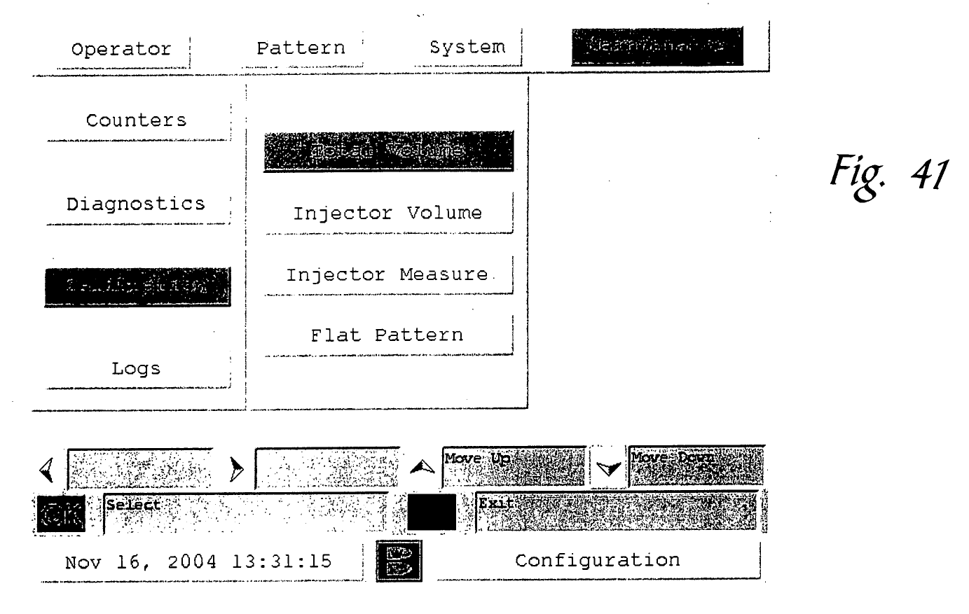

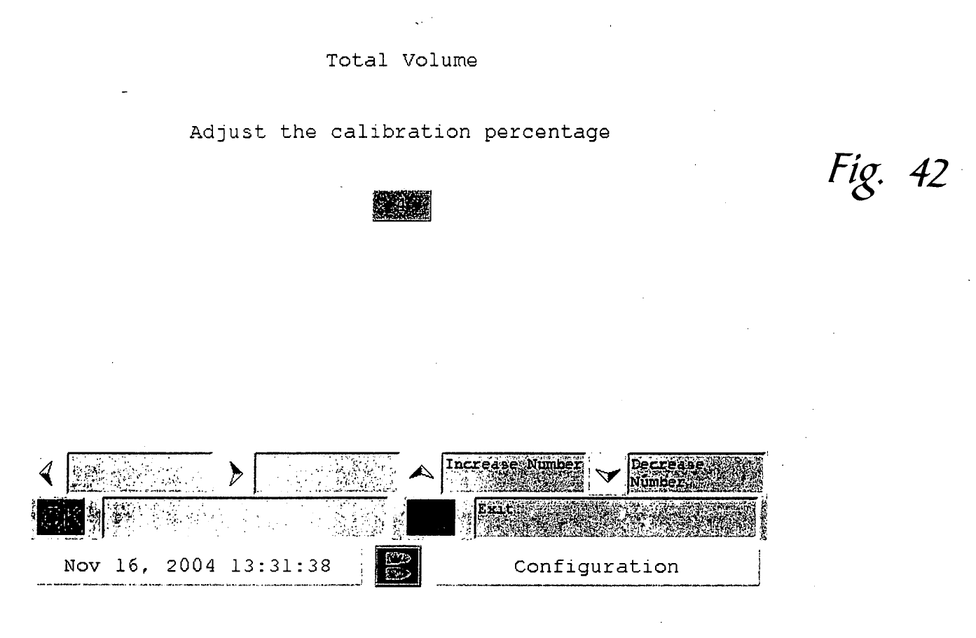

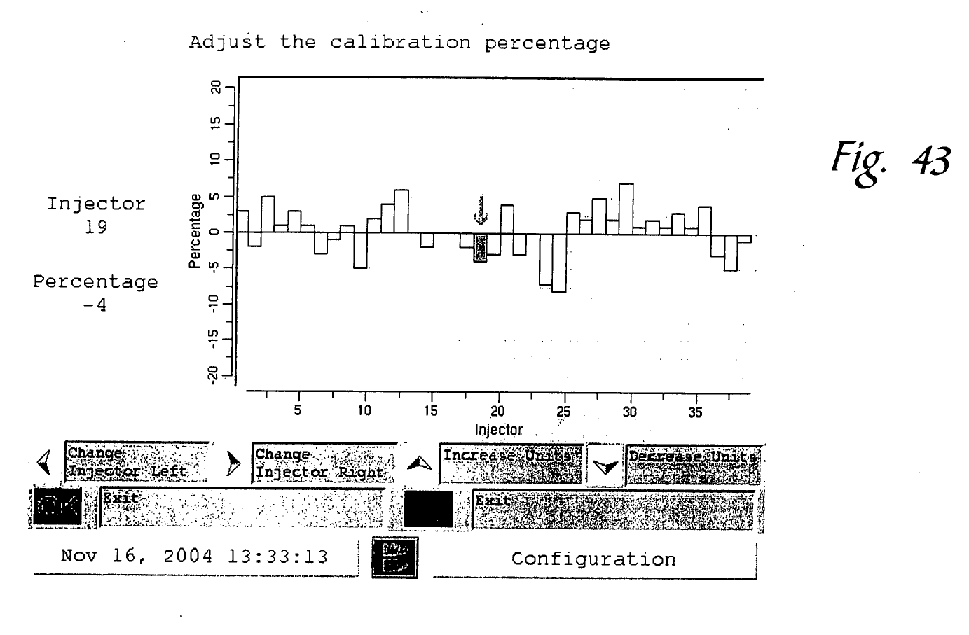

As mentioned above, in this preferred embodiment, the lane machine has 39 independently-controllable injections. The calibration menu (FIG. 41) has four sub-menus: total volume, injector volume, injector measure, and flat pattern that allow a user to calibrate these injectors. The total volume sub-menu (FIG. 42) allows the user to quickly adjust the calibration percentage of all injectors. For example, if the entire pattern is off by 4% because of viscosity or pressure, the user can increase the percentage of all injectors by 4% using this sub-menu. The injector volume sub-menu (FIG. 43) would typically be used at the factory when the lane machine is built. In operation, a technician would cause the injectors to output oil into test cylinders, measure the volume of oil in each cylinder, and compared the measured volume to an expected volume. Variation from the expected volume can be compensated for by adjusting the calibration percentages of the appropriate injectors.

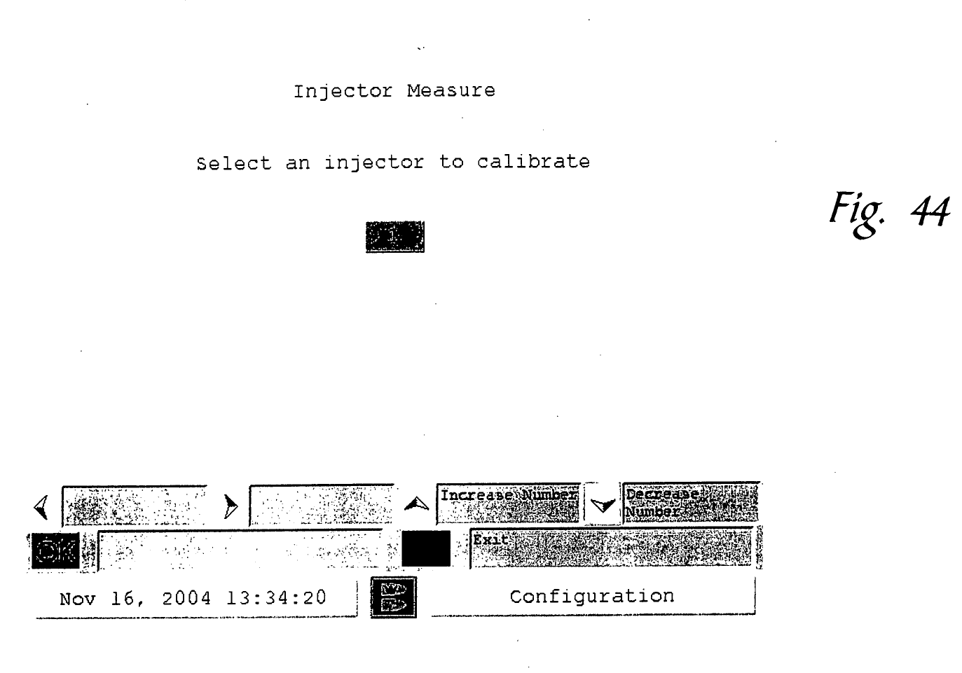

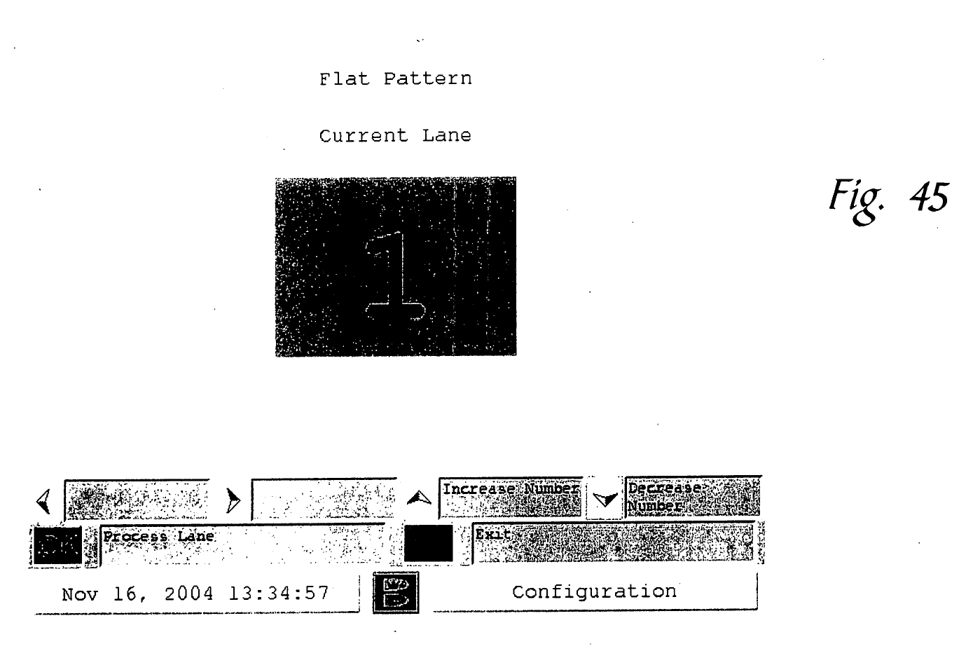

The injector measure sub-menu (FIG. 44) would typically be used by an end user. Instead of measuring the volume output of each injector using test cylinders, a user would use a tape strip to remove oil from a bowling lane and compare the oil actually on the lane with the desired pattern. If there is a discrepancy, the user would use the screen shown in FIG. 44 to select the board were the discrepancy occurred, and another screen would appear (not shown) that would allow the user to adjust the calibration percentage for the corresponding injector. Finally, the flat pattern sub-menu (FIG. 45) provides a shortcut to creating a flat oil pattern for a particular lane (instead of adjusting the oil output of each of the 39 injectors).

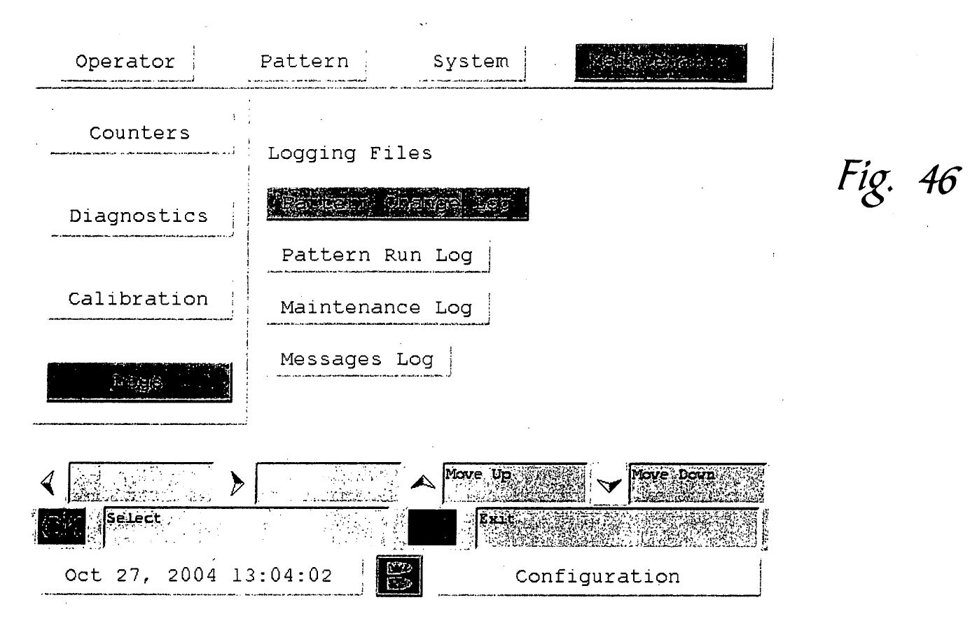

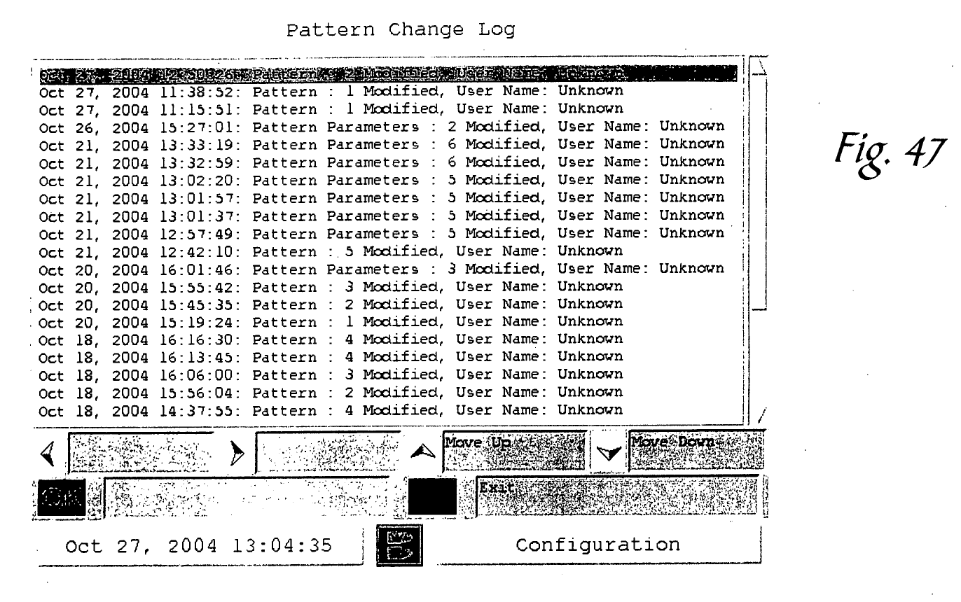

The lane machine in this preferred embodiment comprises a storage device that stores a log of activity of the bowling lane conditioning machine and circuitry operative to display the log on the display device. “Activity” can be any activity of the lane machine, including, but not limited to, the examples provided in this paragraph. Returning back to FIG. 34, when a user selects the logs menu, a screen appears (FIG. 46) showing four sub-menus: pattern change log, pattern run log, maintenance log, and messages log. These logs show their respective data. For example, the pattern change log (FIG. 47) is a historical log of all the pattern changes made on the lane machine. This log can be used to identify any users who make unauthorized pattern changes. All logs preferably have a date and time stamp for each item within the log. In a preferred embodiment, the log files are stored a memory device, such as a CompactFlash or Strata Flash device. The message log stores the date and time of all error, status, and general messages from the User Interface or Controller systems, while the maintenance log stores the text message and counter value relating to the maintenance message information. When the user interface is connected to an Ethernet or modem or other type of network connection, an experienced customer-support person can access the log information to troubleshoot and/or correct a problem. This is especially useful when the machine operator at a bowling center may be so inexperienced that he cannot accurately explain the intentional or unintentional events that preceded the problem. As described above, the network connection can also be used to import/export lane patterns and receive software updates.

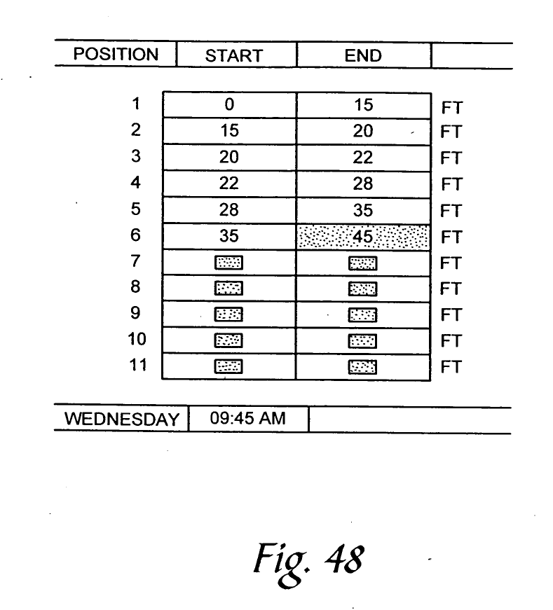

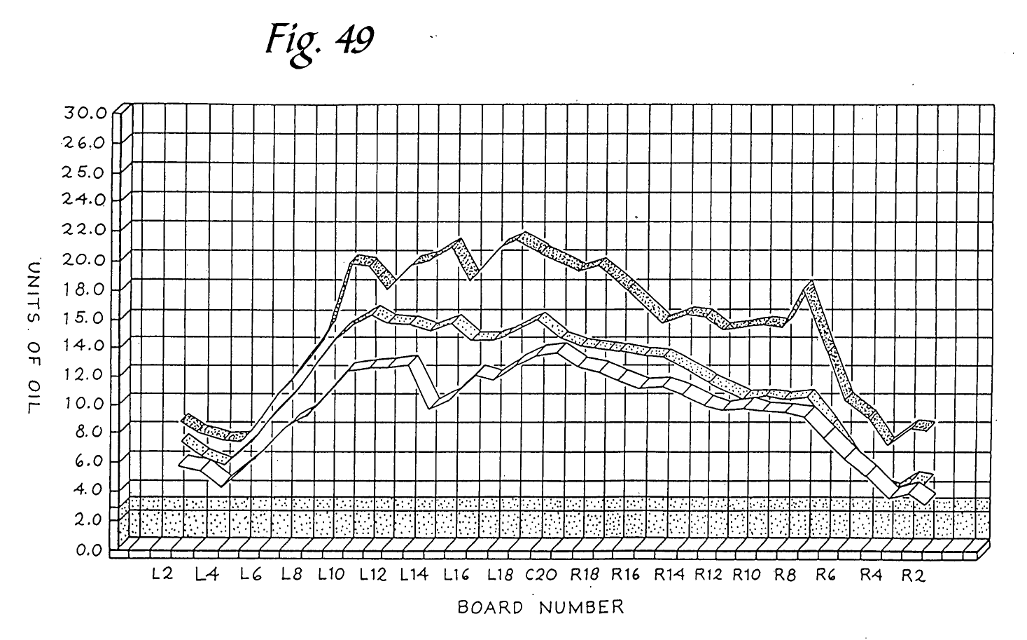

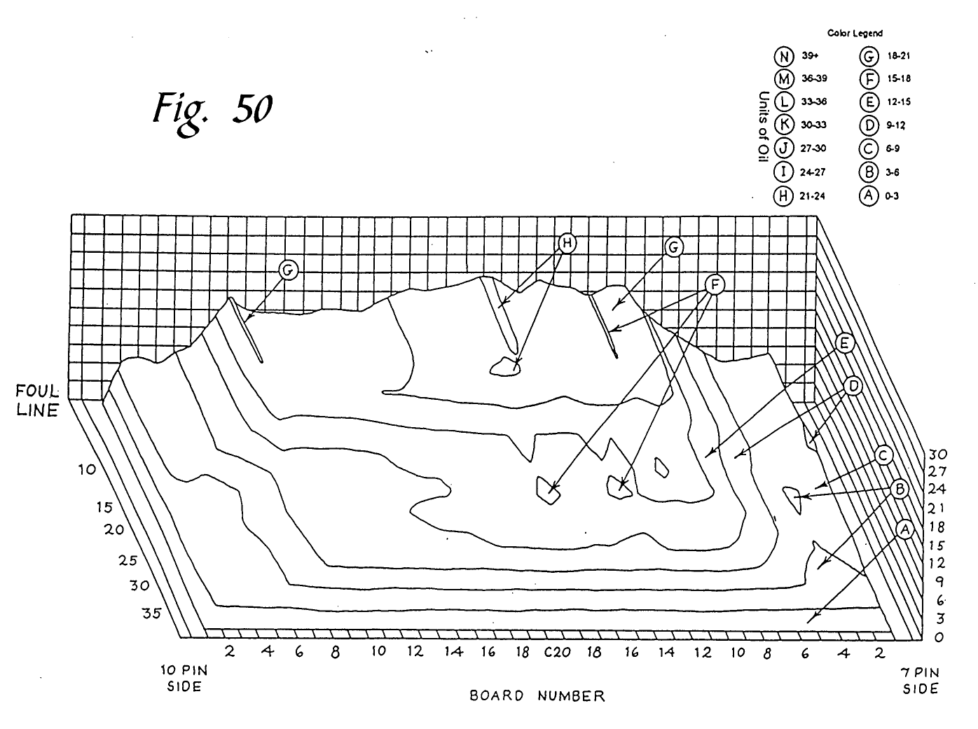

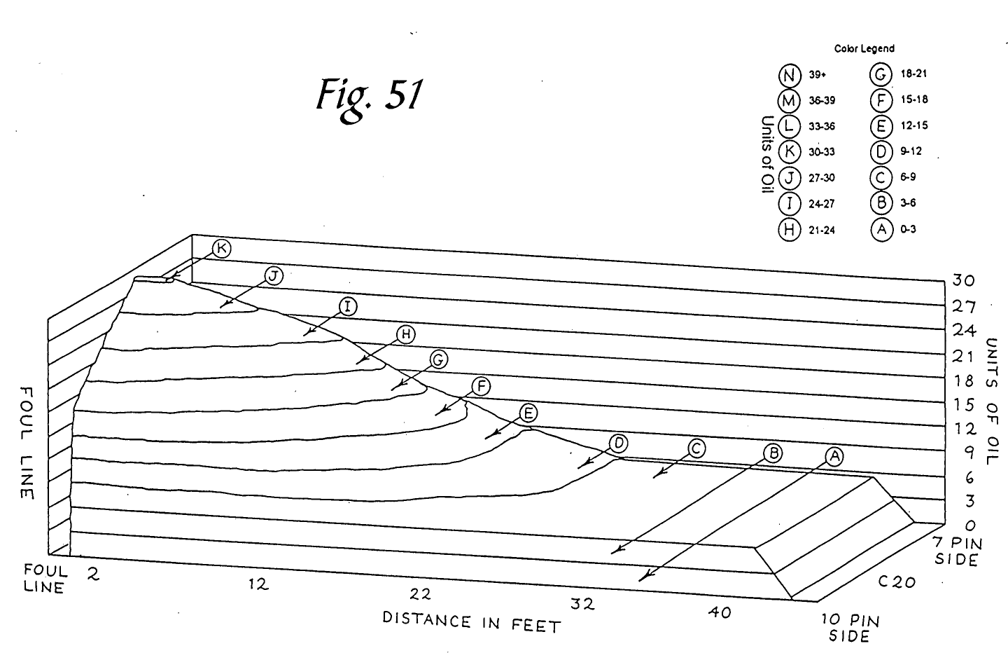

There are several alternatives that can be used with these embodiments. In the examples set forth above, the input received was an “up” or “down” input to increase or decrease distances and amounts. Other forms of input can be used. For example, if the input device comprises a mouse, trackball, or stylus, the user can move a pointer over a zone or oil bar and drag the zone or oil bar to the desired location. As another example, the user can input oil amounts, distances, etc. in a tabular form, such as a spreadsheet. FIG. 48 is an example of a tabular form used to adjust zone lengths. After a value is entered or changed, the graphical representation would be dynamically updated. Also, in the examples set forth above, the graphical representation took the form of a two-dimensional bar graph. Other forms can be used, such as, but not limited to, a line graph (see FIG. 49, which shows line graphs for three zones) and a three-dimensional map (see FIGS. 50 and 51). Of course, other variations can be used.

Further, as noted above, a user interface can implement both or just one of the zone adjustment and oil adjustment functionalities. For example, the user interface can allow a user to adjust the length of a zone without being able to change the lane dressing fluid pattern in a zone, or the user interface can allow the user to change the lane dressing fluid pattern in a zone without changing the length of the zone (e.g., implementing the functionality shown in FIGS. 16-20 without the functionality of FIGS. 21-25, and vice versa). Further, while the bowling lane was divided into zones in the previous examples, these preferred embodiment can be used without the use of zones. For example, instead of the graphical representation in FIGS. 21-25 being for a lane dressing fluid pattern for one of a plurality of zones (here, Zone 2), the graphical representation can be for a lane dressing fluid pattern applied to the entire lane.

It should also be noted that different mechanisms can be used to change an amount of lane dressing fluid to be applied to the bowling lane. For example, in the above examples, zone adjustment and oil adjustment were performed on separate screens. In an alternate embodiment, the same screen is used for both zone adjustment and oil adjustment. If it is desired to change oil on a single board level, the graphical representation of the zones is preferably altered to show each of the 39 boards of a lane instead of grouping the boards as shown in the drawings. Other variations from the examples set forth above are possible. For example, in the above examples, the user was able to change the amount of oil to individual boards of the bowling lane. Instead of changing an amount of lane dressing fluid to be applied to a single board, the input can indicate a change to a plurality of boards of the bowling lane. For example, instead of moving a single bar in the figures referenced above, pressing the up and down arrows can result in moving three bars simultaneously. This alternative may be preferred when the lane dressing fluid application system does not use a 39-injector system.

Also, while the above examples show a user first choosing a predetermined lane dressing fluid pattern from a plurality of stored lane dressing fluid patterns and then customizing the predetermined lane dressing fluid pattern by altering the amount of oil applied and/or the zones, a user can build a lane dressing fluid pattern from scratch instead of customizing a predetermined pattern. Further, while different colors were used to show different amounts of lane dressing fluid, the user interface can be implemented without color (e.g., with numbers, different shapes, etc. indicating the amount of oil). Finally, while the use of boards and zones were used in the above examples, it should be noted that the user interface can be configured to allow the user to indicate a desired amount of lane dressing fluid to be placed anywhere along the longitudinal or transverse lengths of a bowling lane (i.e., without using the concept of boards or zones).

It should again be noted that the various embodiments described herein can be used alone or in combination with one another. For example, a lane machine can have one or more of the following features: a handle with an input device, two input devices, user interface circuitry for zone adjustments, user interface circuitry for changing a lane dressing fluid pattern, and two processors, one for implementing a user interface and the other for controlling a lane dressing fluid application system. It should also again be noted that any appropriate software and/or hardware, analog or digital, not in existence or later developed, can be used to implement the preferred embodiments described above. A computer-usable medium having computer-readable program code embodied therein can be used to perform the functions described above, and the functions described above can alternatively be implemented exclusively with hardware. Additionally, the functionality associated with each element can be combined with or distributed to other elements. It should also be again noted that the menu items and screen shots shown and described herein are merely examples of one implementation. Various layouts, menu items, and options can be added or changed.

The forgoing detailed description has described only a few of the many possible implementations of the present invention. For this reason, this detailed description is intended by way of illustration, and not by way of limitation. It is only the following claims, including all equivalents, that are intended to define the scope of this invention.

What is claimed is:

1. A bowling lane conditioning machine comprising:
a lane dressing fluid application system; and
a user interface system in communication with the lane dressing fluid application system, the user interface system comprising:
a display device;
an input device; and
circuitry in communication with the input device and the display device, wherein the circuitry is operative to:
(a) display a graphical representation on the display device of a lane dressing fluid pattern to be applied to a bowling lane by the lane dressing fluid application system;
(b) receive input from the input device indicating a change to the lane dressing fluid pattern to be applied to the bowling lane by the lane dressing fluid application system; and
(c) dynamically update the graphical representation in response to the input.

2. The bowling lane conditioning machine of claim 1, wherein the input indicates a change in an amount of lane dressing fluid to be applied to a single board of the bowling lane.

3. The bowling lane conditioning machine of claim 1, wherein the input indicates a change in an amount of lane dressing fluid to be applied to a plurality of boards of the bowling lane.

4. The bowling lane conditioning machine of claim 1, wherein the circuitry is further operative to:
display a graphical representation on the display device of at least one zone along a longitudinal length of a bowling lane, wherein each of the at least one zone comprises a respective lane dressing fluid pattern;
receive input from the input device for one or more of the following: adding a zone, deleting a zone, and adjusting a length of a zone; and
dynamically update the graphical representation in response to the input for said one or more of the following.

5. A bowling lane conditioning machine comprising:
a lane dressing fluid application system; and
a user interface system in communication with the lane dressing fluid application system, the user interface system comprising:
a display device;
an input device; and
circuitry in communication with the input device and the display device, wherein the circuitry is operative to:
(a) display a graphical representation on the display device of at least one zone along a longitudinal length of a bowling lane, wherein each of the at least one zone comprises a respective lane dressing fluid pattern;
(b) receive input from the input device for one or more of the following: adding a zone, deleting a zone, and adjusting a length of a zone; and
(c) dynamically update the graphical representation in response to the input.

6. The bowling lane conditioning machine of claim 1 or 5, wherein the circuitry comprises a processor operative to perform (a), (b), and (c).

7. The bowling lane conditioning machine of claim 6 further comprising an additional processor operative to control the lane dressing fluid application system.

8. The bowling lane conditioning machine of claim 1 or 5, wherein the input device is integrated with the display device.

9. The bowling lane conditioning machine of claim 1 or 5, wherein the input device and the display device are separate devices.

10. The bowling lane conditioning machine of claim 1 or 5 further comprising:
a housing carrying the lane dressing fluid application system, wherein the display device is located on the housing.

11. The bowling lane conditioning machine of claim 1 or 5 further comprising:
a housing carrying the lane dressing fluid application system; and
a handle coupled with the housing, wherein the display device is located on the handle.

12. The bowling lane conditioning machine of claim 1 or 5 further comprising:
a housing carrying the lane dressing fluid application system, wherein the input device is located on the housing.

13. The bowling lane conditioning machine of claim 12 further comprising:
a handle coupled with the housing; and
a second input device located on the handle;
wherein the circuitry is operative to dynamically update the graphical representation in response to the input from either the first-mentioned input device or the second input device.

14. The bowling lane conditioning machine of claim 1 or 5 further comprising:
a housing carrying the lane dressing fluid application system; and
a handle coupled with the housing, wherein the input device is located on the handle.

15. The bowling lane conditioning machine of claim 1 or 5, wherein the graphical representation comprises a two-dimensional graphical representation.

16. The bowling lane conditioning machine of claim 1 or 5, wherein the graphical representation comprises a three-dimensional graphical representation.

17. The bowling lane conditioning machine of claim 1 or 5, wherein the graphical representation comprises a plurality of colors, each color indicating a different amount of lane dressing fluid.

18. The bowling lane conditioning machine of claim 1 or 5, wherein the circuitry is further operative to allow a user to choose a predetermined lane dressing fluid pattern from a plurality of stored lane dressing fluid patterns.

19. The bowling lane conditioning machine of claim 18, wherein the circuitry is further operative to allow a user to customize the predetermined lane dressing fluid pattern.

20. The bowling lane conditioning machine of claim 1 or 5, wherein the dressing application system comprises at least one injector comprising at least one opening and a valve.

21. The bowling lane conditioning machine of claim 20, wherein the at least one injector is positioned to output lane dressing fluid directly onto the bowling lane as the bowling lane conditioning machine moves along the bowling lane.

22. The bowling lane conditioning machine of claim 20 further comprising a transfer roller, wherein the at least one injector is positioned to output lane dressing fluid onto the transfer roller.

23. The bowling lane conditioning machine of claim 1 or 5, wherein the dressing application system comprises a spray nozzle.

24. The bowling lane conditioning machine of claim 1 or 5, wherein the dressing application system comprises a pulse valve.

25. The bowling lane conditioning machine of claim 1 or 5, wherein the dressing application system comprises a wick.

26. The bowling lane conditioning machine of claim 1 or 5, wherein the dressing application system comprises a metering pump.

27. The bowling lane conditioning machine of claim 1 or 5 further comprising:
a cleaning fluid delivery and removal system.

28. A bowling lane conditioning machine comprising:
a housing;
a handle coupled with the housing;
a lane dressing fluid application system carried by the housing;
a display device located on the housing; and
an input device located on the handle.

29. The bowling lane conditioning machine of claim 28, further comprising:
a second input device located on the housing.

30. The bowling lane conditioning machine of claim 29, wherein the second input device is integrated with the display device.

31. The bowling lane conditioning machine of claim 29, wherein the second input device and the display device are separate devices.

32. The bowling lane conditioning machine of claim 29, wherein the first-mentioned input device and the second input device comprise identical functionality.

33. The bowling lane conditioning machine of claim 29, wherein the first-mentioned input device and the second input device comprise different functionality.

34. The bowling lane conditioning machine of claim 29, wherein the second input device and the display device are packaged together in a single unit that is removable from the housing.

35. The bowling lane conditioning machine of claim 28, wherein the display device comprises a graphic display.

36. A bowling lane conditioning machine comprising:
a housing;
a handle coupled with the housing;
a lane dressing fluid application system carried by the housing;
a first input device located on the handle; and
a second input device located on the housing.

37. The bowling lane conditioning machine of claim 35, wherein the first and second input devices comprise identical functionality.

38. The bowling lane conditioning machine of claim 35, wherein the first and second input devices comprise different functionality.

39. A bowling lane conditioning machine comprising:
a housing;
a display device carried by the housing;
a lane dressing fluid application system carried by the housing;
a first processor carried by the housing and operative to control the lane dressing fluid application system; and
a second processor carried by the housing and operative to provide a graphic user interface on the display device;
wherein the first processor is operative to operate independently from the second processor.

40. The bowling lane condition machine of claim 39, wherein the first and second processors are configured in a server-client relationship, respectively.

41. The bowling lane condition machine of claim 39, wherein the first and second processors are each associated with respective memories.

42. The bowling lane conditioning machine of claim 39, wherein the first processor is less susceptible to temperature than the second processor.

43. The bowling lane conditioning machine of claim 39, wherein the first processor is less susceptible to shock than the second processor.

44. The bowling lane conditioning machine of claim 39, wherein the first processor is less susceptible to vibration than the second processor.

45. The bowling lane conditioning machine of claim 39, wherein the second processor and the display device are packaged together in a single unit that is removable from the housing.

46. A bowling lane conditioning machine comprising:
a housing;
a handle coupled with the housing;
a lane dressing fluid application system carried by the housing;
a first processor in communication with the lane dressing fluid application system and operative to control the lane dressing fluid application system; and
a user interface system in communication with the first processor and comprising:
a display device located on the housing;
a first input device located on the housing;
a second input device located on the handle; and
a second processor in communication with the display device the first and second input devices, the second processor being operative to provide a graphic user interface on the display device; wherein the first processor is operative to operate independently from the second processor.

47. A bowling lane conditioning machine comprising:
at least one of a lane dressing fluid application system, and a cleaning fluid delivery and removal system;
a display device; and
circuitry in communication with the display device and operative to:
(a) receive a user request for activation of a component of the bowling lane conditioning machine; and
(b) display confirmation on the display device that the component completed a desired function.

48. The bowling lane conditioning machine of claim 47, wherein the component is part of the lane dressing fluid application system.

49. The bowling lane conditioning machine of claim 47, wherein the component is part of the cleaning fluid delivery and removal system.

50. The bowling lane conditioning machine of claim 47, wherein the component comprises a drive motor.

51. The bowling lane conditioning machine of claim 47, wherein the component comprises an end-of-lane sensor.

52. The bowling lane conditioning machine of claim 47, wherein the component comprises a speed sensor.

53. The bowling lane conditioning machine of claim 47, wherein the circuitry is further operative to display the following on the display device: a first set of display regions indicating which components a user can request activation of, and a second set of display regions that indicate confirmation that the component completed a desired function.

54. A bowling lane conditioning machine comprising:
at least one of a lane dressing fluid application system, and a cleaning fluid delivery and removal system;
a display device;
a storage device storing a log of activity of the bowling lane conditioning machine; and
circuitry in communication with the storage device and the display device, the circuitry operative to display the log on the display device.

55. The bowling lane conditioning machine of claim 54, wherein the log comprises a pattern change log.

56. The bowling lane conditioning machine of claim 54, wherein the log comprises a pattern run log.

57. The bowling lane conditioning machine of claim 54, wherein the log comprises a maintenance log.

58. The bowling lane conditioning machine of claim 54, wherein the log comprises a messages log.

59. The bowling lane conditioning machine of claim 54, wherein the log stores at least one of a date and time for each activity in the log.

60. The bowling lane conditioning machine of claim 54, wherein the log stores pattern changes made on the bowling lane conditioning machine.

61. The bowling lane conditioning machine of claim 54, wherein the log stores at least one of an error message, a status message, and a general message from a user interface or controller system of the bowling lane conditioning machine.

62. The bowling lane conditioning machine of claim 54, wherein the log stores at a text message and counter value.

63. The bowling lane conditioning machine of claim 54 further comprising a network connection in communication with the circuitry, wherein the circuitry is operative to provide the log to an external device via the network connection.

64. The bowling lane conditioning machine of claim 63, wherein the network connection comprises an Ethernet connection.

65. The bowling lane conditioning machine of claim 63, wherein the network connection comprises a modem.

66. A bowling lane conditioning machine comprising:
at least one of a lane dressing fluid application system, and a cleaning fluid delivery and removal system;
a display device; and
circuitry in communication with the display device and operative to change a language of text displayed on the display device.

67. The bowling lane conditioning machine of claim 66 further comprising:
a storage device in communication with the circuitry, the storage device storing a plurality of files, each file comprising text of a different language;
wherein the circuitry is operative to access a file associated with a language requested by a user.

68. The bowling lane conditioning machine of claim 66, wherein the circuitry is operative to change the language of text displayed on the display device without a need to restart the bowling lane conditioning machine.

69. A bowling lane conditioning machine comprising:
at least one of a lane dressing fluid application system, and a cleaning fluid delivery and removal system;
a display device; and
circuitry in communication with the display device and operative to display a graphical user interface on the display device, wherein the graphical user interface displays a plurality of menu options including a menu option of a presently-displayed screen, wherein the menu option for the presently-displayed screen is displayed differently from the menu option for a screen displayed prior to the presently-displayed screen.

70. The bowling lane conditioning machine of claim 69, wherein menu option for the presently-displayed screen is displayed in a first color, and wherein the menu option for the screen displayed prior to the presently-displayed screen is displayed in a second color.

71. The bowling lane conditioning machine of claim 69, wherein one of the menu options allows a user to specify a lane dressing fluid pattern.

72. The bowling lane conditioning machine of claim 69, wherein one of the menu options allows a user to add, delete, or adjust a length of a zone along a longitudinal length of a bowling lane.

73. The bowling lane conditioning machine of claim 45, wherein the second processor comprises a dedicated, single-purpose computer.

74. The bowling lane conditioning machine of claim 45, wherein the second processor is operative to be programmed after the single unit is removed from the housing.

75. The bowling lane conditioning machine of claim 45, wherein the single unit comprises a memory device that retains its stored programming when removed from the housing.
